(19) United States
(12) Patent Application Publication
(10) Pub. No.: US 2018/0131240 A1
(43) Pub. Date: May 10, 2018

(54) SYSTEMS AND METHODS FOR BUSINESS POWER MANAGEMENT PERTAINING TO WIRELESS POWER TRANSFER

(71) Applicant: POWERMAT TECHNOLOGIES LTD., Neve ILan (IL)

(72) Inventors: EDUARDO ALPERIN, RAANANA (IL); AMI OZ, AZOR (IL); RACHEL BEN HANOCH, GIVAT SHMUEL (IL); IAN PODKAMIEN, PETACH TIKVA (IL)

(21) Appl. No.: 15/106,407

(22) PCT Filed: Dec. 17, 2014
(86) PCT No.: PCT/IL2014/051107

§ 371 Date: Jun. 20, 2016

(51) Int. Cl. H02J 50/80; H02J 13/00; G06Q 50/06

(52) U.S. Cl. CPC H02J 50/80; H02J 50/10; G06Q 50/06; H02J 13/001

(57) ABSTRACT

The disclosure relates to providing system and methods for providing business and personal wireless power management functionality in a wireless power transfer network using a power management software application including monitoring and gathering data pertaining to the mobile device and the wireless power transfer network and further enable intelligent business data analysis of such a network. The wireless power transfer system allows wireless power transfer to electrical mobile devices of users such as smartphones, laptops and the like, at home, office and various public areas, and may be centrally monitored and controlled. The mobile device may be operable to execute the power management software application to enable monitoring and data gathering managing mobile device power related events, such as when the power level runs low and further enables to monitor and control power transfer. The software package may use various inputs, shared information, user experiences, ranking of the social space.

### FIELD OF THE DISCLOSURE

The disclosure herein relates to systems and methods for providing business power management to wireless power transfer. In particular, the invention relates to electrical device software applications for managing business associated power related requirements based upon gathering business data in a wireless power transfer network, used to transfer power to mobile electrical devices at home, office and public areas and further combining with elements such as battery state, user preferences and location and the like.

### BACKGROUND OF THE INVENTION

The spread of mobile devices such as mobile handsets and smartphones, media players, tablet computers and laptops/notebooks/netbooks and ultra-books increases user demand for access to power points at which they may transfer power to charge mobile devices while out and about or on the move.

There is a need for systems that conveniently provide the opportunity to transfer power for power transfer power to mobile devices in public spaces, in which the user of the mobile spaces may remain for extended periods of time, say more than a few minutes or so. Amongst others, such public settings may include business entities such as restaurants, coffee shops, airport lounges, trains, buses, taxis, sports stadia, auditoria, theatres, cinemas or the like. Further, there is a need for such systems to enable easy tracking of individual mobile devices and of power transfer locations in public spaces as soon as the need arises, for example, when battery level runs low. Thus, this need requires to provide a business platform to answer business entities needs and user expectations, based upon monitoring system usage and data gathering to provide business various matters such as arranging payment, charging/powering service, and offer commercial opportunities.

Furthermore, such a computerized and distributed environment of inductive power components deployment involving provisioning functionality, payments, billing information, complex distribution and configurations, monitoring needs, controlling and the like, while involving a large community of individuals with various needs and requirements, monitoring and gathering data for further intelligent business data analysis, is required, to better answer business needs.

The invention below addresses the above-described needs.

### SUMMARY

A system for monitoring and gathering data pertaining to an inductive power transfer network includes at least one inductive power transfer component operable to manage power transfer between an inductive power outlet and an inductive power receiver, at least one management server in communication with the at least one inductive power transfer component, and a database in communication with the management server and operable to store data received by the management server from the at least one inductive power transfer component, wherein the at least one management server is operable to: receive a communication request comprising at least one power transfer data package from the at least one inductive power transfer component; and store the at least one power transfer data package to the database.

In various embodiments, the at least one power transfer data package comprises data pertaining to at least one of the group consisting of: location of the at least one inductive power transfer component, characteristics of the inductive power receiver, characteristics of the inductive power outlet, power status data, recordation timestamps, power transfer duration, user specific identification, business of the location and combinations thereof. Embodiments may include a system further comprising at least one dashboard terminal in communication with the management server and operable to access the database and present the data received by the management server. The system may be further operable to generate reports, wherein the reports comprises at least one of the following: a representation of geographical spread of use of the at least one inductive power transfer component; a representation of usage over time of the at least one inductive power transfer component; a representation of power status information of a mobile device; and a representation of an individual user interactions to identify repeating users pattern.

Embodiments may include a system operable to generate reports that comprises selecting a report template from a template repository, the report template being characterized by a definition comprising at least one of the group consisting of: location of the at least one inductive power transfer component, characteristics of the inductive power receiver, characteristics of the inductive power outlet, power status data, recordation timestamps, power transfer duration, user specific identification, business of the location and combinations thereof. The system may be configured to monitor at least one inductive power transfer component, such that the management server receives multiple periodic data packages at intervals from the at least one inductive power transfer component being monitored.

Embodiments according to the present disclosure may include a computer implemented method for gathering data pertaining to an inductive power transfer network, the network comprising: (1) at least one inductive power transfer component operable to manage power transfer between an inductive power outlet and an inductive power receiver; (2) at least one management server in communication with the at least one inductive power transfer component; and (3) a database in communication with the management server and operable to store data received by the management server from the at least one inductive power transfer component, the method comprising: the management server receiving a communication request from the at least one inductive power transfer component, wherein the communication request comprises at least one power transfer data package; the management server obtaining data received from the at least one power transfer data package; and the management server storing the data received into the database.

The system may include at least one power transfer data package comprising data pertaining to at least one of the group consisting of: location of the at least one inductive power transfer component, characteristics of the inductive power receiver, characteristics of the inductive power outlet, power status data, recordation timestamps, power transfer duration, user specific identification, business of the location and combinations thereof.

The method may further include the management server accessing the database; the management server obtaining data from the database; the management server presenting the data on a dashboard. The inductive power transfer network may further comprise a dashboard terminal for presenting the data, and the method further comprises: the management server formatting the data; and the management server transmitting the formatted data to a dashboard terminal. The method may further comprise the management server generating a report, which may include generating at least one of the following: a representation of geographical spread of use of the at least one inductive power transfer component; a representation of usage over time of the at least one inductive power transfer component; a representation of power status information of a mobile device; and a representation of an individual user interactions to identify repeating users pattern.

In various embodiments, the method may include the management server receiving a request for a report associated with a template specification; the management server selecting a report template according to the template specification from a template repository; the management server obtaining data for the report according to the report template; and the management server populating the data into fields of the report template. Template specifications may be selected from the group consisting of: location of the at least one inductive power transfer component, characteristics of the inductive power receiver, characteristics of the inductive power outlet, power status data, recordation timestamps, power transfer duration, user specific identification, business of the location and combinations thereof.

The method may further comprise the management server monitoring the at least one inductive power transfer component, wherein the monitoring is receiving multiple periodic data packages at intervals, from the at least one inductive power transfer component, and/or the management server controlling the at least one inductive power transfer component.

Embodiments of the disclosure include an electrical device comprising: a power storage unit operable for receiving power transfer; a wireless power receiver operable to connect to a wireless power outlet; a data storage component operable to store power pertaining data; and a processor operable to: receive current position of the electrical device; and receive current power level of the power storage unit; wherein the processor is further operable to generate an alert according to the current position, the current power level and the power pertaining data. The wireless power receiver is operable measure the current power level of the power storage unit. The power storage unit is selected from the group consisting of: a rechargeable battery, an electrochemical cell and combinations thereof. The processor is further operable to determine user preferences and store them in the data storage component. In various embodiments, the electrical device is in communication with a remote server operable to transmit the power transfer pertaining data. The electrical device may further include a positioning system selected from the group consisting of: a satellite positioning system, a radio signal positioning system, and a cellular network and combinations thereof. The current position may be received from the positioning system. The current position may be received from the wireless power outlet.

In some embodiments, the power transfer pertaining data is selected from the group consisting of: user specific identification data, user specific contract data, power transfer business policy, characteristics of at least one business around the current location, set of adverts associated with the at least one business, recordation timestamps and combinations thereof. The electrical device may be in communication with at least one member of a social network.

Embodiments may also include a computer implemented method for receiving data pertaining to a wireless power transfer network on an electrical device, the electrical device comprising: (1) a power storage unit operable for receiving power transfer; (2) a wireless power receiver operable to connect to a wireless power outlet; (3) a data storage component operable to store power transfer pertained data; and (4) a processor, the method comprising the processor receiving power transfer pertaining data; the processor storing the pertaining data in the data storage component; the processor receiving current position of the electrical device; the processor receiving current power level of the power storage unit; and the processor, generating an alert according to the current position, the current power level and the power pertaining data. The method may include measuring the current power level of the power storage unit. The power storage unit may be selected from the group consisting of: a rechargeable battery, an electrochemical cell and combinations thereof.

In some embodiments, the method includes the processor determining user preferences and storing the user preferences in the data storage component. The step of receiving power transfer pertaining data may include a remote server communicating with the electrical device and remote server transmitting the power transfer pertaining data to the processor. The electrical device may further comprise a positioning system selected from the group consisting of: a satellite positioning system, a radio signal positioning system, and a cellular network and combinations thereof with the step of receiving current position comprising the positioning system determining the current position and communicating the current position to the processor. The method may include receiving current position by the wireless power outlet communicating the current position to the processor. The power transfer pertaining data may be selected from the group consisting of: user specific identification data, user specific contract data, power transfer business policy, characteristics of at least one business around the current location, set of adverts associated with the at least one business, recordation timestamps and combinations thereof. The method may also include the user of the electrical device selecting a social network, selecting at least one member of the social network, and transmitting the at least one member a communication message.

### BRIEF DESCRIPTION OF THE DRAWINGS

For a better understanding of the embodiments and to show how it may be carried into effect, reference will now be made, purely by way of example, to the accompanying drawings.

With specific reference now to the drawings in detail, it is stressed that the particulars shown are by way of example and for purposes of illustrative discussion of selected embodiments only, and are presented in the cause of providing what is believed to be the most useful and readily understood description of the principles and conceptual aspects. In this regard, no attempt is made to show structural details in more detail than is necessary for a fundamental understanding; the description taken with the drawings making apparent to those skilled in the art how the several selected embodiments may be put into practice. In the accompanying drawings:

FIG. 1A is a schematic representation of selected elements of a distributed system for powering electrical devices with a wireless power receiver, accessible via power management software application.

FIG. 1B is a schematic representation of selected elements of a distributed wireless power transfer system for powering electric devices with a wireless power receiver, via local gateways;

FIG. 2 is a block diagram representing a possible software module architecture of a distributed system providing wireless power transfer;

FIG. 3A is a schematic representation of possible information flow of business data gathering in a distributed system providing wireless power transfer;

FIG. 3B is a schematic representation of possible information flow of business data between components in a distributed system providing wireless power transfer;

FIG. 4 is a flowchart representing selected actions of a possible method for backend processing of a communication request for business data gathering in a distributed system of wireless power transfer;

FIG. 5A is a flowchart representing selected actions of one possible action flow to store inductive power related data in a management database;

FIG. 5B is a flowchart representing selected actions of another possible action flow for generating a dynamic report of wireless power transfer related data.

FIG. 5C is a flowchart representing selected actions of still another possible action flow for generating a static report of wireless power transfer related data.

FIG. 6A is a flowchart representing selected actions of a possible method to store power transfer related data into a database, operable on the application node;

FIG. 6B is a flowchart representing selected actions of a possible method for power transfer related data retrieval, operable on the application node;

FIG. 7A is a block diagram representing one possible set of static reports, operable to be retrieved via the application node;

FIG. 7B is a flowchart representing selected actions of one possible method to generate a dynamic report of power transfer related data, operable on the application node;

FIG. 8A is a possible representation of a geographical spread of use report of active wireless power transfer units (hotspots);

FIG. 8B is a possible representation of service usage over time combined with active sessions, to produce one possible sample of a geographically based statistics report; and

FIG. 8C is another possible representation of a service usage over time report in a specific location.

FIG. 9 is a block diagram representing selected actions of a possible procedure for providing the end user with a complete analysis set of results, upon low power level notification.

FIG. 10 is a flowchart representing selected actions of one possible action flow between components of the multi-node wireless powering client server system;

FIG. 11 is a flowchart representing selected actions of a possible method for processing a power management notification;

FIG. 12A is a possible screen shot representing a home screen of a power management software application, which may be installed and accessed from a mobile device;

FIG. 12B is a possible screen shot of a “remaining battery time” based on the user's real usage pattern of a power management software application;

FIG. 12C is a possible screen shot of an additional battery data such as battery health, type of technology, temperature and current voltage of a power management software application;

FIG. 12D is a possible notification message overlaid upon a home screen of a mobile device, such as a mobile phone or the like;

FIG. 12E is a possible screen shot of a “Low Power” popup screen of a power management software application;

FIG. 12F is a possible screen shot of a “Power Access Point Locator” screen of a power management software application;

FIG. 12G is a possible screen shot of a “Get Directions” screen of a power management software application; and

FIG. 12H is a possible example of a display of a locator feature using augmented reality to indicate the locations of nearby power provision points of a power management software application.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

Aspects of the present invention relate to providing system and methods for power management of electrical mobile device, using a power management software application of the current disclosure and gathering data pertaining to a wireless power transfer network to enable business data analysis of such a network.

The data gathering system of the current invention may use a deployment of at least one wireless power transfer component operable to manage power transfer between an inductive power outlet and an inductive power receiver, at least one management server in communication with the at least one wireless power transfer component, and a database in communication with the management server and operable to store data received by the management server from the at least one wireless power transfer component.

The inductive power outlet may be operable to execute a software module with near communication features to communicate with the electronic mobile device, perform identification to verify user credentials and allowances, and further communicate with the management server. The management server may be operable to receive communication requests from the inductive power outlet comprising at least data package to enable gathering of detailed user usage information, power status information and store the data in a database. The gathered data may include location and geographical information, user and device ID and other possible identification data, battery level information and the like.

The power management software application provides a platform covering power management aspects while in the public space. Optionally, the software application is automatically triggered when the mobile device requires power transfer providing various options for the user, directing him to the nearest power transfer service provider based on power storage unit status (battery power level), user preferences and current location. Optionally, the power management software application may use additional inputs or shared information such as user experiences and ranking of various members of the social space environment.

The power management software application of the current disclosure, is operable for receiving data pertaining to a wireless power transfer network on an mobile device, where the mobile device may include: a power storage unit operable for receiving power transfer, a wireless power receiver operable to connect to a wireless power outlet, a data storage component operable to store power transfer pertained data and a processor, where the processor comprising the steps of: receiving power transfer pertained data, storing the pertained data in the data storage component, receiving current position of the mobile device, receiving current power level of the power storage unit and generating an alert according to these parameters, for example by determining and displaying a power transfer related recommendation in response to changes in the current position and the current power level, based on the stored power transfer pertained data.

Further, the power management software application may be operable to be executed on a mobile device enabling to manage power requirements within a wireless power transfer network. The power transfer network system, may use a deployment of at least one wireless power transfer component (in the public space) operable to manage wireless power transfer between a wireless power outlet and an a power receiver (a mobile device), at least one management server in communication with the at least one wireless power outlet, and a database in communication with the management server and operable to store data received by the management server from the at least one wireless power transfer outlet.

Where appropriate, the wireless power transfer system may allow wireless power transfer to electrical devices of users such as mobile devices, smartphones, tablet computers, laptops and the like, at home, office and various public areas, and may be centrally monitored and controlled.

The system may allow a user to retrieve various sections and views of the stored data, perform data analysis, generate various types of usage reports, static or dynamic, monitor the network or parts of it and the like.

The system may further allow a dashboard interface presented via a web based application, for example, for presenting geographical spread of use, usage over time generally and in specific venues, individual user filtered data, remote hardware status and the like.

It is noted that the wireless power outlet may be operable to execute a software module with near communication features to communicate with the electrical mobile device, perform identification to verify user credentials and allowances, and further communicate with the management server. The management server may be operable to receive communication requests from the wireless power outlet comprising at least data package to enable gathering of detailed user usage information, power status information and store the data in a database. The gathered data may include location and geographical information, user and device ID and other possible identification data, battery level information and the like.

As used herein, the term “virtual session” or “session” refers to a hosted session of a virtual computing environment associated with a particular user that may be accessed from one or more client devices other than the host. For example, a session may include a thin client session, a virtual application session, a virtual machine session, a virtual operating system session, and/or the like. As used herein, a session described as being “between” a host device and a terminal device refers to the exchange of data between the host device and the terminal device, where the data is related to the session hosted at the host device.

As used herein, the term “terminal device” refers to a device configured to provide a user interface for a remotely hosted virtual session to a user associated with the virtual session.

As used herein, the term “management server” refers to a server configured to manage multiple inductive power outlets configured to provide power transfer to electrical mobile electrical devices, and controlling the power charging between an electrical mobile device and an associated inductive power outlet. The term “management server” may be referred to herein as, variously, as a “control server”, “central server” or a “server”.

As used herein, the mobile electrical device may be referred to herein as, variously, a “user device”, an “electrical device”, a “mobile device”, a “communication device” or a “device”. The device may be an electronic device with a battery, e.g., a mobile handset, a media player, a tablet computer, a laptop/notebook/netbook/ultra-book, a PDA or the like. Alternatively, the device may be an accessory with a battery, such as earphones and the like, or a stand-alone battery. As a further alternatively, the device may be any powered device, including electronic devices without a battery.

The inductive power outlet point may be referred to herein as, variously, a “PAP”, a “hotspot” or a “charger”.

As used herein, the term “memory” or “memory unit” may represent one or more devices for storing data, including read-only memory (ROM), random access memory (RAM), magnetic RAM, core memory, magnetic disk storage mediums, optical storage mediums, flash memory devices or other computer-readable mediums for storing information. The term “computer-readable medium” includes, but is not limited to, portable or fixed storage devices, optical storage devices, wireless channels, a “SIM” card, other smart cards, and various other mediums capable of storing, containing or carrying instructions or data

For the purpose of clarity in description, the following description describes systems, devices, methods, and software for dynamically updating a session based on data received from an access card reader. However, it should be understood that the same principles may be applied to the receipt of authentication data from any type of peripheral or standalone access or authentication device, including access card readers, smart card readers, biometric data readers, keypads, buttons, near field communications (NFC) devices, and the like.

### System's Architecture

Some embodiments representing the current system's architecture may use Client/Server technology, but are not limited and may use other network architectures such as a peer-to-peer architecture, where each node has equivalent responsibilities.

In software engineering, Client/Server architecture refers to a network architecture where each computer, device or process on the network is either a client or a server. Such network architecture are applicable to enterprise applications, and generally the presentation, application processing, and data management functions are logically separated and operable on various nodes (tiers) of the system.

The client software (may be referred to as the user agent) allows the interaction between the client machine (a dashboard terminal, a workstation, a dedicated inductive power outlet or an electrical mobile device) and the application layer. When web-based applications are used, the client node (usually a browser) renders the user interface, which may be generated by a presentation layer on the client side or the server side by interpreting the HTML, Java applets, or ActiveX controls, for example.

The presentation layer is software allowing the visualization functions for the application (on a dashboard terminal, electrical mobile device) and may comprise of static objects such as images, form fields receiving retrieved data from the database layer, or may use dynamically generated objects to allow populating the data appropriately, and displaying the result of the analysis or computation produced by the application layer. The output of the presentation layer may be submitted to a dashboard, and further formatted to be presented on a terminal dashboard, for example. On web-based applications, the presentation layer may be implemented by web servers.

The application layer provides the business logic of the data gathering system and its software may be installed on a management server. The application layer may receive procedure invocations from the presentation layer, to which it returns the results of the application logic (computation or the analysis) performed on the management server. The application layer may further communicate with the database layer to store, update and retrieve data. The management database layer may store the application data, such as user information, geographical location, device ID, power transfer duration and additional related information. The management database software may be installed a separate server (node) or be installed on the management server. In any case, a database interface may be required in order to implement the business logic, allowing connecting to the database server(s) to retrieve and save data.

The application layer provides the business logic of the distributed system of wireless power transfer network and the management software may be installed on a management server. The application layer may receive procedure invocations from the presentation layer, to which it returns the results of the application logic (computation or the analysis) performed on the management server. The application layer may further communicate with the database layer to store, update and retrieve data. The management database layer may store the application data, such as business logic and policies, third party business related information, user information, geographical locations, device IDs, power transfer duration and additional related information. The management database software may be installed on the management server or on a separate server (node). For any case, a database interface may be required in order to implement the business logic, allowing connecting to the database server(s) to retrieve, update and store data.

It is noted that in software engineering, such a complex client/server network architecture in which presentation, application processing, and data management functions are logically separated are referred to as a multi-tier architecture. The most widespread use of multi-tier architecture is the three-tier architecture, where the client may be the first tier (presentation layer), the management server is the second tier (application logic processing) and the database server is the third tier (data management).

It is further noted that the client side may be represented by a thick-client or a thin-client. A thin-client may be a computing device that includes hardware, software, or both in a client-server architecture network, where most of the application logic is performed on the server side. In some examples, a thin-client device may run web browsers or remote desktop software, such that significant processing may occur on the server.

Further, the interaction between the electrical mobile device and the inductive power outlet may fit under the technology of two tier Client/Server architecture, where the inductive power outlet behaves as the server. Additionally, the inductive power outlet, in a mode of transmitting data, serves as a client responding to application logic requests (from the management server).

Client-server architectures, in their simplest form, are sometimes called two-node (tier) architecture. Three-node (tier) architecture of a Client/Server system is typically composed of a presentation node, a business or data access node, and a data node.

### Data Gathering—Management and User Identification

It is noted that data gathering of a wireless power transfer system deployment, distributed in various geographical locations may provide additional revenue channels to a business using advanced data analysis methods applicable to the gathered data, and may offer direct and indirect incentives to business and individual users related by adding to future purchase of goods, maintenance, deployment changes to answer demand and the like, by providing a data analysis layer of usage reports, statistics and trends, for example.

In order to enable this type of model, a simple and convenient method may be required for associating a user with a specific electrical mobile device and to a specific inductive power outlet (wired or wireless), based upon identification data, and possibly synchronized by a close handshake communication of the devices.

The current disclosure relates to a system for enabling this task to be accomplished automatically and with no user intervention. The system may utilize preexisting transmitters that may be common amongst many mobile electronic devices with additional software management applications to them. Such an implementation may allow for the mass deployment of the system with little or no additional cost or inconvenience to the user.

It is particularly noted that although described primarily in relation to inductive power chargers, the current disclosure may apply to any power providing schemes and are not limited to say wired or wireless charging schemes.

The data gathering distributed system may employ various user interfaces operable on various systems and technologies to answer user interaction requirements as well as system administration needs.

The data gathering distributed system may provide software application user interface running on a terminal dashboard, for example, optionally as a web-based software application, and further, may have various functionality running on different type of terminals and mobile devices.

The management user interface operable functions of the data gathering distributed system, may provide customer configuration management portal and an administrator management portal or a combination thereof.

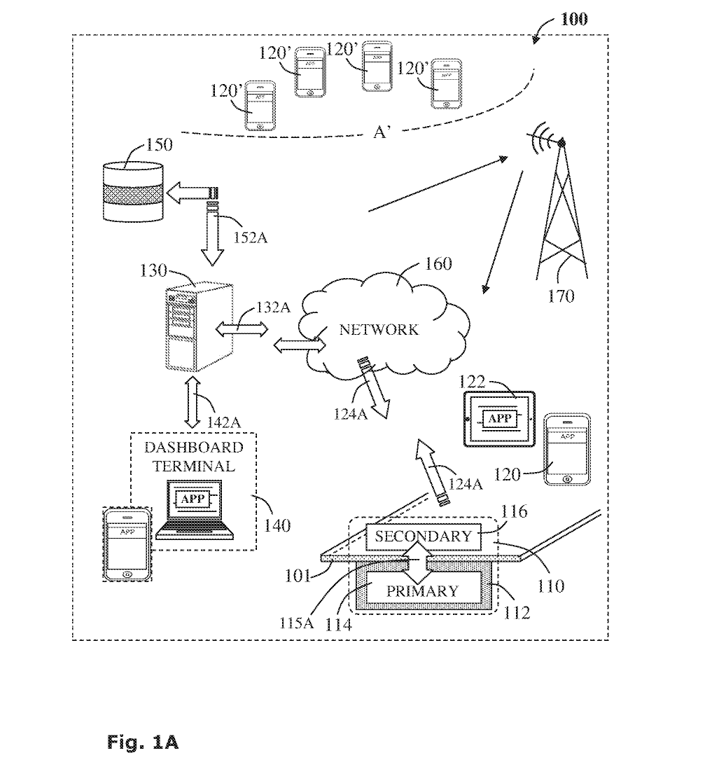

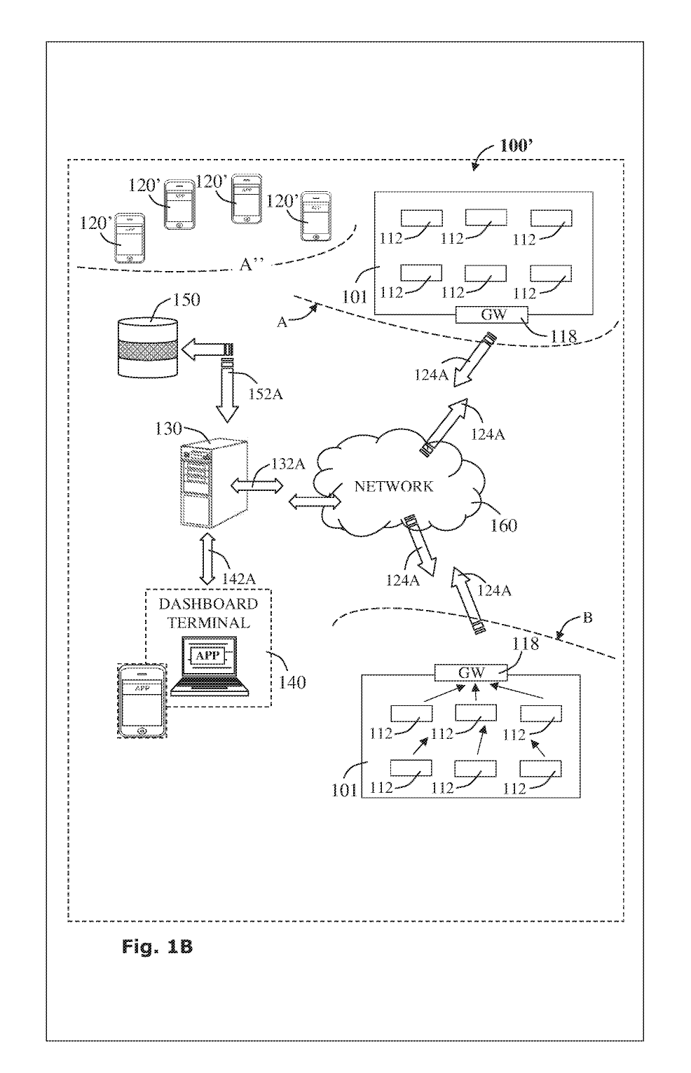

The customer configuration management portal may support functions of remote maintenance such as installing/uninstalling a gateway (as 118, in FIG. 1B), installing/uninstalling an inductive power outlet (a hotspot as 112, in FIG. 1B), replacing a gateway or an inductive power outlet, security features, live view of a venue, data usage files and online activity reports, power transfer policy and the like.

Where appropriate, the customer configuration management portal may be supported on various browsers such as Internet explorer; Firefox; Chrome; Opera and the like.

Where appropriate, the customer configuration management portal may be viewable on screen resolutions such as 1024×768 pixels; 1280×720 (1280×800) pixels; 1920×1080 (1920×1200) pixels; and 2048×1536 pixels.

Optionally, a login page may be provided to accept user credentials of user name and password, and password should be verified for strength.

Optionally, the customer configuration management portal may use various screens to allow various functional manageability, such as: Inductive power outlet management tab, Venues management tab, Users' management tab, Policy management tab, Reports tab, Auditing tab for configuring and managing systems' events, Security management tab and the like.

Optionally, Inductive power outlet management tab may allow the following: summary view of live status, and detailed view of a specific store to allow managing the store's hotspots and gateways.

Optionally, the Users' tab may allow the following: create a new customer's administrator, create or delete a store, assign or reassign a store to a customer administrator (a system administrator functionality), assign or reassign stores to an operator, install a store (with gateways and hot spots), perform uninstall operations of various components, enable or disable users of a customer, issue reports for all the venues and the like.

It is noted that a system administrator is higher in hierarchy than a customer administrator. Further, a customer administrator may add/remove/disable a user in the system. Where appropriate, disabling a user means the user is blocked from login temporarily, while the account still exist. Enabling the account will restore all privileges that existed prior to disabling.

Optionally, the Venues management tab may allow the following: list stores in a venue, create a new venue, and delete an existing venue. Additionally, the following flows are supported in the Venues management tab: installing/uninstalling a gateway, installing/uninstalling a hotspot, managing a gateway, managing a hotspot of an individual level and at a store level. Additionally, the Venue tab may allow viewing of a stores' list view, a specific store view, and specific hot spot, and further show gateway details view and hotspot details view. Further, upgrading software or firmware of a hotspot may be available, creating an auditing message and optionally transmitting a notification to the user initiating the operation. Optionally, the system may provide a mechanism to allow upgrade of a store, or a set of multiple stores.

Optionally, the Reports tab may allow the following: display graphical representation and textual output files of a single device, a single store or multiple stores; each report may be adjusted to visualize data for a defined week/month/quarter within the last 12 months; the graphical reports may be viewed, printed, or saved to a file in a graphical format, or saved to file in a data format used to generate the report. As appropriate, the generated reports may provide usage per store of the total power transfer time in minutes, say, for a defined period, where store may be identified by a store ID; charging hotspot utilization for a 24 hour cycle, say, providing the average daily time, in minutes say, per a hotspot per a store; usage per date and trend, providing total power transfer time, in minutes say, per date for all stores, with a linear trend line and possibly, define weekdays and/or weekends in the display; sessions, providing distribution of lengths of sessions and average session length; charging per time of day providing total charging minutes for all stores per hour of day for the defined period; repeat usage, providing rate of returning users and number of repeat visits for power transfer; and device type providing distribution per type of device.

Optionally, the Auditing tab may allow the following: create log data for every important event in the system, including: installation or removal of a gateway, installation or removal of a hotspot, rejecting a hotspot as a not “legitimate” hot spot (not in production database), definition or cancelation of a user, customer or store, creation of SN generator file and others.

Optionally, the Policy management tab may allow the following: creating basic policy for power transfer per each day of the week, weekend specific power transfer policy, time slot resolution per a hotspot (or all hotspot in a store) such as a hotspot is active between 8 am-1 pm and 4 pm-7 pm, for example. Further, a policy may be executed at once on all hotspots per store, such as disabling all hotspots or enabling all. Optionally, when an hotspot is configured as ‘not available’ per policy, it's status may be indicated a the LED color, red say, for ‘unavailable’.

It is noted that hotspots availability should never be less than the advertised time.

### DESCRIPTION OF THE EMBODIMENTS

It is noted that the systems and methods of the invention described herein may not be limited in its application to the details of construction and the arrangement of the components or methods set forth in the description or illustrated in the drawings and examples. The systems, methods of the invention may be capable of other embodiments or of being practiced or carried out in various ways.

Alternative methods and materials similar or equivalent to those described herein may be used in practice or testing of embodiments of the invention. Nevertheless, particular methods and materials are described herein for illustrative purposes only. The materials, methods, and examples are not intended to be necessarily limiting.

Accordingly, various embodiments may omit, substitute, or add various procedures or components as appropriate. For instance, it should be appreciated that the methods may be performed in an order different than described, and that various steps may be added, omitted or combined. Also, aspects and components described with respect to certain embodiments may be combined in various other embodiments. It should also be appreciated that the systems, methods, devices, and software may individually or collectively be components of a larger system, wherein other procedures may take precedence over or otherwise modify their application.

Reference is now made to FIGS. 1A-B schematically representing a distributed system 100 and 100′ for providing power transfer for mobile devices, combined with business data gathering of wireless power transfer to electrical mobile devices, according to the current disclosure. The distributed power transfer system 100 of FIG. 1A provides external network connectivity and internet access by each inductive power outlet, while the distributed system 100′ of FIG. 1B provides the external network connectivity for each inductive power outlet via the local venue gateway(s) 118.

It is noted that the power management and business data gathering software provides functionality of device power storage management combining the status of the power storage unit of the electric mobile device, user preferences and current location to offer various power related recommendations and directing the user to the nearest power transfer location, accessible according to the potential locations of servicing wireless power transfer.

FIG. 1A schematically representing a distributed system 100 for providing business power management including data gathering pertaining to wireless power transfer for electrical devices, according to the current disclosure. The distributed business power management system 100 comprises a wireless power transfer component 110, a management server 130, a management database 150, a communication network 160 and a mobile communication network 170. Optionally, the distributed data gathering system 100 comprises a dashboard terminal 140.

Optionally, the distributed wireless power management 100 may be used for external network connectivity and internet access for each wireless power outlet 112, providing wireless power transfer technology and at least one location for wireless power transfer for electrical devices, searchable by the power management software application, according to the current disclosure. The distributed system 100 comprises a wireless power transfer component 110, a management server 130, a management database 150, a communication network 160 and a mobile communication network 170. The section noted ‘A-A’ of FIG. 1A, represents the public space of users, using mobile devices 120′ installed with a power management software application.

Optionally, the distributed wireless power management system 100 comprises a dashboard terminal 140.

Optionally or additionally, the users within the public space noted ‘A-A’, each using an electrical mobile device 120′ connectable via the social network, enabling to share data and information with other member of the social community.

The wireless power transfer component 110 comprises two sub-components, the inductive power outlet 112, optionally embedded into a surface 101, comprises a primary inductor 114 and connectable to power supply (not shown) and an electrical mobile device, such as a smartphone 120 and tablet 122, each comprising a secondary inductor 116 connected to a load and capable of coupling with the primary inductor 114 to allow wireless power transfer to the electrical mobile device. The inductive power outlet 112 may be referred to as a hotspot (HS) and may further include a LED display operable to display on/off/dimmer/fade-in-out signals.

It is noted that the electrical mobile device 120, 122 may each have a unique identifier, which may be referred to as a receiver identification (RxID). The electrical mobile device 120, 122 may be identified by an inductive power outlet 112 when the electrical device 120, 122 and the inductive power outlet 112 are in close proximity. The inductive power outlet 112 may have a unique identifier, which may be referred to as a transmitter identification (TxID).

It is further noted, that communication between the inductive power outlet 112 and the electrical device 120, 122 may use the communication channel 115A to communicate between one another, and optionally establish credential exchange to allow power provisioning.

The inductive power outlet 112 may communicate with the communication network 160 via the communication channel 124A, allowing internet-based communication, further communicating with the management server 130 through a communication channel 132A. Variously, the communication channel 152A may further be used to communicate with the management database 150, in a standalone database configuration, or having the management server and the management database installed on the same machine.

Optionally, the inductive power outlet 112 may communicate externally using cellular communication infrastructure 170.

The communication process between the inductive power outlet 112 and the management server 130, may be operable to perform sending of various periodic status and non-periodic events. The various events may include TxID, RxID identification parameters and additional information such as starting power transfer, stopping power transfer, modifying service in some way, receiving server permission commands, on/off commands for aborting power provision or resuming, charging balance status and the like.

The terminal dashboard 140 (optionally other types of clients, such as electrical mobile devices and the like) may use the communication channel 142A to communicate with the application layer of the management server 130.

It is noted that the wireless power outlet 112 may communicate with the electrical mobile device 120, 122 exchanging identification information as described in the “Data gathering—Management and User Identification” section, and further send periodic status messages and non-periodic events to the management server 130. This type of communication, while using the wireless the power transfer provides exact indication of the current location of a user, if any other positioning system is not operable, to provide more accurate location bases recommendation combined with user preferences.

FIG. 1B schematically representing a distributed power transfer system 100′ for providing business wireless power management including business data gathering of electrical mobile devices, communicating externally via a local venue gateway, according to the current disclosure. The distributed business power management system 100′ comprises two sets of inductive power outlets 112 located in area A and B, a local venue gateway 118, a management server 130, a management database 150, a communication network 160 and a mobile communication network 170. Optionally, the distributed business power management system 100 comprises a dashboard terminal 140, while the section noted ‘A-A’ of FIG. 1A, may represent the public space of users, using mobile devices 120′ installed with a power management software application.

Optionally or additionally, the users within the public space noted ‘A-A’, each using an electrical mobile device 120′ connectable via the social network, enabling to share data and information with other member of the social community.

The section noted ‘A-A’ of FIG. 1B, represents the public space of users, using mobile devices 120′ installed with a power management software application.

The inductive power outlet 112 may be capable of communicating with the local venue gateway 118, wirelessly or using the venue Ethernet resources. The local venue gateway 118 has access to the communication network 160 through communication channel 124A, enabling the inductive power outlet 112 to send periodic status and non-periodic events and reporting the management server 130.

It is noted that area A and area B represent two different sets of inductive power outlets, where each inductive power outlet of in a set may communicate event notification messages via the local venue gateway 118, possibly according to setting configuration of the local venue gateway 118 or the setting of the inductive power outlet 112 itself. Optionally, the inductive power outlet 112 may be configured to function in dual mode, either through the local venue gateway 118 or communicate directly with the communication network 160, to provide improved online functioning. Thus, the inductive power outlet 112 of the distributed system 100′ may differ from similar units of the system 100 of FIG. 1A.

It is further noted areas A and B, may represent separate rooms, for example, in the same venue, or may represent separate installations in different venues. Further, a single gateway 118 may manage a limited number of inductive power outlets, say six, and if the deployment requires more inductive power outlets, additional gateways may be a required.

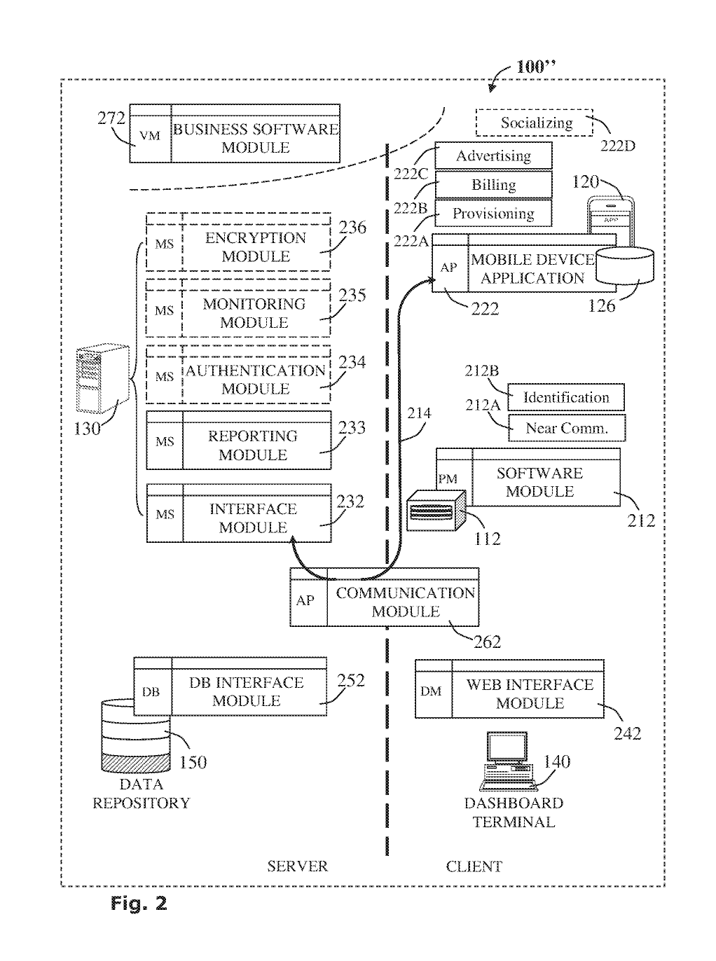

Reference is now made to the block diagram of FIG. 2, representing possible distributed software modules' architecture for business power management of a system 100″ providing wireless power transfer, optionally including data gathering.

The distributed business power management system 100″ comprises an inductive power outlet 112, an electrical mobile device 120, a management server 130, a data repository 150, and a communication network (not shown). Optionally, the distributed business power management system 100″ comprises a dashboard terminal 140 and may additionally comprise a business entity machine (not shown) such as a vendor machine and the like.

The inductive power outlet 112 may include a software module with sub-modules such as a near communication module 212A and an Identification module 212B. Optionally, an additional sub-module may provide network communication (not shown) with the management server, via internet connectivity or through a local business gateway (not shown).

Optionally, the electrical mobile device, connectable to a local storage unit 126, may further be installed with a mobile device power business application 222 with sub-modules such as a provisioning 222A, billing 222B and advertising 222C and Socializing 222D.

Optionally, the management server 130 may include the following modules: interface module 232, report generation module 233 and optionally an authentication module 234, a monitoring module 235 and an encryption module 236.

The data repository 150 comprises a database (DB) interface module 252. The DB interface module may be sub-divided into several sub-modules, if the data repository is made up of several databases or additional secondary data sources exist.

Further, the communication module 262 allows communication to be established between the various components. The communication module may use various communication technologies to allow the communication between the various components, such as communication between the inductive power outlet unit and the electrical mobile device, communication between the inductive power outlet and the management server, and the communication between a dashboard terminal and the management server.

It is noted that the use of the term “communication module” does not imply that the components or functionality described or claimed as part of the communication module, as described hereinafter, in the communication module section, are all configured in a common package.

Optionally, if a business entity machine exist such as a vendor machine exists, it may need to be installed with a vendor specific software module 272, operable to interface with the management server 130, accordingly.

Optionally, if a dash board terminal exists, it needs to be installed with an appropriate web-interface module 242, for example, to allow access and visualization of the distributed system.

### The Communication Module

The communication module reflects various aspects of the communication requirements between the components of the wireless power transfer distributed system, and may differ while answering different communication needs of the components. For example, the communication needs between the electrical mobile device and the inductive power outlet expose different functionality and technology in comparison to the communication needs between the inductive power outlet and the management server. Thus, when referring to the communication module, it is intended to clarify the various aspects and the communication technology that may be associated with specific interaction.

### Communicating with the Management Server

Optionally, the electrical mobile device may have a wireless LAN/WAN communication unit, which does not necessarily have to match the LAN/WAN transmission unit of the inductive power outlet. Furthermore, the electrical mobile device may include a near communication module capable of communicating with the module on the inductive power outlet.

The management or control server may be in communication with the inductive power outlet, the electrical mobile device, or both. The communication channel may be mediated by wireless access points, cellular networks (FIG. 1A), wired networks or the like that may provide an internet protocol (IP) connection to at least one of the electrical devices or the inductive power outlet. It is further noted that optionally, the communication channel to the inductive power outlet may be mediated indirectly via the electrical device and the close communication module. Similarly, the communication channel to the electrical device may be mediated indirectly via the inductive power outlet.

### Tx-Rx Communication

Each electrical device may have a unique identifier, which may be referred to as a receiver identification (RxID), in the system that allows the recognition thereof. The RxID may be a MAC address. The management server may store user or electrical device related information in addition to the RxID, such as power transfer RELATED data, billing information, user credits or the like.

Where appropriate, inductive power outlets may have a unique identifier, which may be referred to as a transmitter identification (TxID), in the system that allows the recognition thereof.

For illustrative purposes only, possible methods for providing access to power for electrical devices in public spaces are presented hereinafter. The method may allow a user to transfer power or charge an electrical device such as a mobile phone, a tablet or the like from an inductive power outlet and may further allow a power provider to manage the power provision, while gathering power transfer related information.

A user may place or connect an electrical device to an inductive power outlet. For example an inductively enabled device may be placed upon an inductive power outlet. Alternatively, or additionally, a power supply may be conductively connected to an electrical device.

The power access point may detect the electrical device connection. For example, wired connection may be detected by detecting the load and wireless connection may be detected using various remote sensors such as hall sensors, analog ping schemes or the like.

### Initial Authentication/Handshake

The inductive power outlet may enable power transfer for a predefined time T_{free} during which time period user credentials may be authenticated.

Optionally, the inductive power outlet may transmit a random pattern to the device via the close communication. The inductive power outlet may further transmit that same pattern to a control server via a WAN/LAN connection.

For example, a software application running on the electrical device may be operable to receive the pattern and to relay the same pattern to the management server along with user identification token.

Variously, the management server and electrical device may exchange multiple messages to complete authentication of the user.

The management server may thereby be able to associate the specific inductive power outlet with the specific electrical device. If the user is deemed permitted to use the service the management server may send a confirmation signal allowing the inductive power outlet to continue servicing the electrical device. Where required, the confirmation signal may define a specific time period for which the service is granted or send a disconnect event on termination of that time.

Where appropriate, the management server may additionally or alternatively define multiple levels of service, for example, as expressed in terms of current provided to different users. By way of example, paying users may be enabled to access full powering capability, perhaps up to 20 watts or so, while non-paying users may be provided limited access to say 0.5 watts which may be sufficient to charge only low power devices or perform trickle charge for completely depleted batteries.

During operation the inductive power outlet may be operable to receive operating signals from the management server. According to the operating signals received, the inductive power outlet may be operable to perform various actions such as to continue providing power, to abort power provision, to modify the service in some way or the like.

As noted herein, various methods may be implemented for enabling close communication between the electrical device and the inductive power outlet.

### Audio Communication

In one particular embodiment, the close communication channel between the device and power access point may be based upon audio signals sensed via a microphone of the electrical device, for example using specific audible bands, 300 Hz-20 khz, say. The audio signal may be emitted from an audio emitter such as a speaker or the like associated with the inductive power outlet. Many electrical devices, such as mobile phones and the like have microphone and software applications may have access to the microphone.

It is noted that powering the microphone unit may itself demand power. Consequently, the software application running on the electrical device may activate the microphone only where ‘a-charge-connect’ event is detected in the system. Accordingly, upon device detection the inductive power outlet may provide an initial power transfer to power the microphone. After a short interval, an identification signal may be sent via the audio signal.

The audio signal may include additional tones that are not related to the communication pattern which may mask the random patterns communicated. For example, an audio identification signal may be masked by a connection tone serving to provide users with an indication that a connection has been made.

### Data-Over-Coil (DOC) Communication

Alternatively or additionally, the close communication channel may be provided by the inductive power outlet alternating the activation of power transfer to the electrical device. The alternation of power supply is detected by most electrical devices as power transfer connection and disconnection events that are communicated to the application layer on these electrical devices.

The switching pattern may be coded with an identification signal such as the random pattern. The inductive power outlet may need to perform this switching in intervals spaced sufficiently apart to allow the electrical devices to detect and report to application level power transfer connection and disconnection events.

### Bluetooth and NFC

Still other embodiments may use Bluetooth or Near Field Communication (NFC) to achieve the close communication channel. These could be combined with the basic power signal to trigger their activation thereby conserving power.

In various embodiments of this system the LAN/WAN interface of the device may be WLAN or Cellular 2G/3G/4G connections. The connection to the WLAN or Cellular access point may also include manual or automatic insertion of user credentials. In this case the information may be conveyed to the management server to enable user identification. The information provided in order to allow access may also be stored by the device application and later provided directly to the management server.

Additionally, or alternately the LAN/WAN connection of the inductive power outlet may be achieved via the charged device. The inductive power outlet may encrypt messages to the management server and deliver this to the application on the electrical device via the close communication channel therebetween. The application may then send the message to the server via its LAN/WAN connection.

### Mobile Device—the Software Application

The mobile device, business power management software application may provide several sub-module components covering various possible functionalities, such as provisioning, billing, advertising, communication and the like. Optionally, the software application may allow modular functionality, to provide interfaces to additional features.

The inductive power outlet may include an identification module to allow authorized usage, a near communication or the like. They may optionally also include a wireless LAN/WAN transmission unit module (as described hereinabove, in the communication module section).

The electrical mobile device may be operable to execute a business power management software, including provisioning functionality for paid charging, enabling the monitoring and controlling of power transfer. Such business power management software may be an application that is preinstalled or accessed via a computer network such as by downloading from ‘apps store’ or operating as a web-based application. Further, the operation of the electrical device, in relation to the wireless power transfer system described herein, may be controlled by software embedded within the OS of the device, the application programming interface (API) of the device OS, or firmware. The business power management software may be distributed among a combination of: software embedded within the OS; the application programming interface (API) of the device OS, firmware, a pre-installed or downloaded application; and/or a web-based application. For example, the interaction of the device user with the charging system may be mediated with a preinstalled or downloaded application, while the interaction of the device with the other components of the wireless power transfer system such as the inductive power outlet and the server may be mediated through OS-embedded software.

The business power management software may run on an electrical device having a user interface. Alternatively, the device may not have a user interface.

The business power management software application may be automatically launched when power transfer is initiated on the electrical device. Alternatively the user may launch the provisioning software, and then allow the power transfer of the device to commence.

The business power management and provisioning software application or the web-based application may further comprise additional functionalities to allow for more traffic, improve user satisfaction, provide brand exposure, and add direct revenues or the like. The Application may use features such as low battery notifications, locating a power transfer spot, directions to the power transfer spot, associated power transfer related or mobile device accessories for purchase. Additionally or alternatively, the application may provide power transfer history in general, optionally per location, receiving adverts based upon location, user identification, battery status, rate of power transfer and the like. Optionally, the pushed advertising may be coupled with promotional codes to facilities within venue area.

Optionally, the mobile device business power management software application may allow promotion through social networks to get discounts on ‘Like’, share location with friends and inviting them to join.

Optionally the mobile device business power management software application may allow ranking the power transfer experience.

Optionally the mobile device software application may allow providing skins or themes for a desired configuration of look and feel.

### Power Management—User Interaction

The power management software application may provide for user interaction that comprises one or more of the following features: the user may be able to open a user account, the user may be able to register one or more electrical devices that are associated with his account. Registered electrical devices may have one or more of the following properties: owner contact details (email, SMS phone number or the like), permission to contact using supplied contact details, Model, User ID (text), user-name (optional, could be different family members) and place of purchase.

Optionally, the user may be provided with access to usage information, e.g., usage graphs, report on history of Hotspot visits, and the like. Information may be presented per user or per device. Further, the user may be provided with access to an online store for components relevant to the charging system or its use, or with a guide to retail stores providing the same. The online store may allow purchase of power transfer times, permissions, and the like.

Optionally, the user may be provided with access to charging time available, or to a report regarding the same information.

As appropriate, the information and recommendations may be presented to the user through the application, or through other communication means available on the device, e.g., email, SMS, and the like.

It is noted that the power management software running on the device may receive the TxID and/or the location of the wireless power outlet (Hotspot). Information regarding the location of the Hotspot may be associated with the TxID. Such location information may be programmed into the Hotspot at, e.g., the time of installation, and may provide very accurate location information, which may be more accurate than what may be provided through other methods, such as a satellite positioning system for example GPS or the like, alternatively antenna triangulation may be used. Where the power management software is an application, the Hotspot may transmit information regarding itself (e.g., TxID, location, and the like) to the electrical device, which then transfers the information to the application. The application may further identify the location using satellite positioning, antenna triangulation, in-door positioning methods, wireless network access point signals, such as WiFi communications and the like.

Further, the application may interact with the operating system (OS), e.g., through the OS's API, to use the electrical device's communication capabilities to connect to the server and, e.g., request the charging policy for the device in relation to the Hotspot or Hotspot location, at the given day/time, and receive the allowance policy details to charge the device. If communication with the server cannot be established, the application may allow the providing of charge based on a predefined “offline policy”.

### Business-to-Business Integration of the Server

The server may be capable of integration with external servers or services. Some integration may be for data enhancements and external validation of rights for users, and others may be for managing a certain functional aspect of the system, such as: User management; Billing; Advertising; socializing and Policies management with external dependencies

Various functionalities may be available through the power management software, and may also be available in third-party applications through application programming interfaces (APIs) for the server or another client application. Without limiting the scope of the application, selected functionalities may include, amongst others: using satellite positioning, antenna triangulation, wireless network locations or in-door positioning location information to display a map with nearby public hotspots; booking a Hotspot in advance, and accordingly, the booked Hotspot will not charge for other users, only for the registered user when he arrives, and identified by the unique RxID; registering devices; checking power transfer statistics; buying accessories, charging policies; checking real-time power transfer balances for registered devices; setting notification methods, receiving notifications; setting an automatic check-in to the Hotspot location setting automatic interactions with social networks, e.g. automatic check-ins, tweets, status updates, and the like; providing store-specific promotion updates via push notifications, for example, based on past and current usage of power transfer services and user's micro-location; using accumulated information of the usage of the wire transfer service, including locations and the like, to better target users with promotions/ads; creating loyalty plans for venues based on usage of the wire transfer services in their premises; providing services to users based on information that their social-network connections are/were at a close proximity; and launching a third party application on a user's device based on past or current usage of power transfer services and user's micro-location.

### Database Interfacing

The management server may provide an Application Program Interface (API) to allow the various component applications to access the management server, with further applicable access to data stored in the database(s). Accessing the database directly from the management server may use a command shell, which may come bundled with about every database selected.

The data may be stored in tables (relational database such as Oracle, Informix, Microsoft SQL Server and more), objects (object oriented database) or documents/files (documented oriented database such as XML—Extensible Markup Language) and the like.

The database, having a stand-alone installation or installed on the same physical machine, may be accessed through a common database interface such as Sequence Query Language (SQL).

Alternatively, the database may be accessed by an object orientated API, providing database-abstraction API to create, retrieve, update and delete objects, or use XML based API or the like.

It is noted that that each API may be implemented in various computer languages such as C, C++, C#, Java, JavaScript, Python and the like.

It is also noted that the interaction with the database may be transaction base, allowing to configure a set of commands For example, anything between the ‘transaction start’ and ‘transaction commit’ methods are not executed until ‘transaction commit’ is called, if no exception occurs. Rolling back the changes and cancelling operation may use a ‘transaction rollback’ method, returning the database to the original state if a problem occurs even though a number of changes may have executed to the database's tables.

### The Encryption Module

The Encryption Module may be responsible for encrypting instructions from the server to the inductive power outlet, and may further be delivered to the charged device which will relay them back to the inductive power outlet via the close communication channel.

Where applicable, the encryption may only allow the server and inductive power outlet to encrypt/decrypt the messages but would prevent the charged device from altering or creating a legal message. Accordingly, the transfer of the messages from server to inductive power outlet may require the existence of a bidirectional close communication channel. For audio signals this may be achieved by using the device speaker and including a microphone on the inductive power outlet.

Additionally or alternatively, a bidirectional power based signaling scheme may be achieved by modulating the load of the device on the inductive power outlet. As many devices do not allow applications to directly control the charging current used or the system load, it may be required to use some indirect techniques such as modulating screen illumination back light for LCD and direct pixel activation for OLED to vary the load.

It is further noted that wireless power transfer systems may offer additional options for close communication channels.

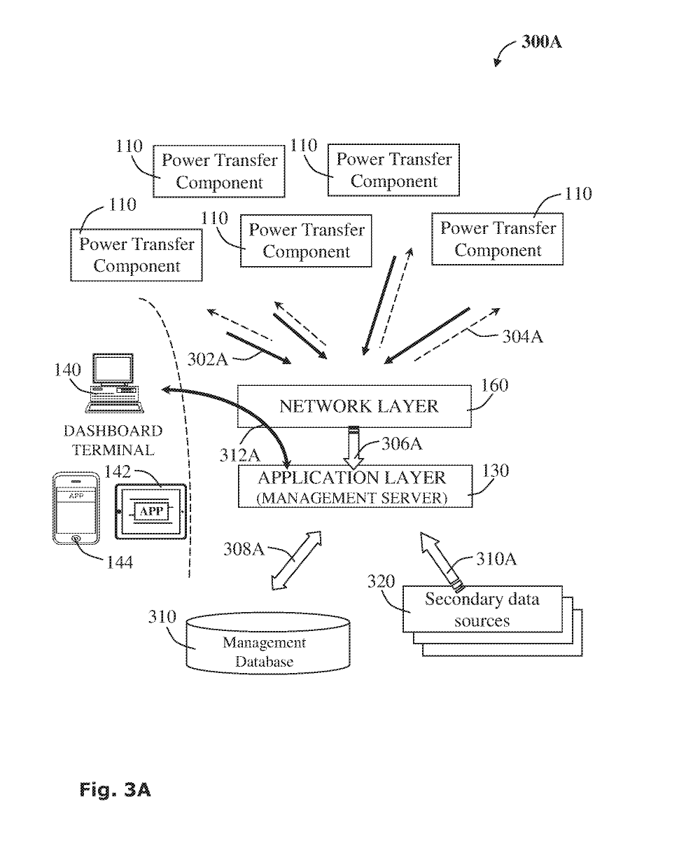

Reference is now made to black diagram of FIG. 3A showing a schematic representation of possible information flow 300A in a distributed business data gathering system. The schematic representation of possible information flow 300A includes a possible set of wireless power transfer components 110 (inductive power outlet and an electrical mobile device) communicating business data via a communication channel 302A to the application layer of the management server 130, through a network layer 160 and a communication channel 306A between the network layer 160 and the application layer 130. The schematic representation of possible information flow 300A may further include possible information flow between the application layer of the management server 130 and the management database 310 via communication channel 308A. The application layer of the management server 130 may further initiate communication when accessing secondary data sources 320 via communication channel 310A. Further, communication may be initiated by a client node such as a terminal dashboard 140, a tablet 142 or an electrical mobile device 144 through a communication channel 312A, which may further use communication channel 306A to reach the application layer of the management server 130.

It is noted that a wireless power transfer component 110 may be configured to initiate communication with the application layer of the management server 130, transmitting business data at time intervals via channel 302A, in a push mode. Additionally or alternatively, the system may be configured to support pull mode, or a combination thereof, where the initiation of a communication request may be performed by the application layer of the management server 130, thus the communication channel 304A may be operable to support dual mode communication.

It is further noted that the raw data output from the lowest node (the wireless power transfer component) may be used as the input data to the whole integrated data gathering system, and may further undergo some formatting to answer possible requirements.

Reference is now made to the diagram of FIG. 3B showing a schematic representation of possible information flow 300B in a distributed system providing wireless power transfer services. The schematic representation of possible information flow 300B includes a wireless power outlet 112 as a power transmitter (located in a public area) and an electrical mobile device 120 having a wireless power receiver (116, FIG. 1A) in communication with the management server 130, through network 160.

The communication on the server side is controlled through the interface layer 232 implementing a communication channel 306A with the network 160, further interacting with the server application layer 130′.

The communication on the client side is controlled through the power management software application 125 installed on the mobile device 120, using channel 124A to communicate with the network 160. The device 120, may further communicate with a data storage unit 126 for purposes of the power management software application.

The schematic representation of possible information flow 300B may further include possible information flow between the server application layer 130′ and the management database 310 via communication channel 308A. The application layer 130′ may further initiate communication when accessing secondary data sources 320 receiving business related data for example, such as powering policies, advertisements and the like, via communication channel 310A.

The schematic representation of information flow 300B further includes the public space, indicated by “A-A” area, includes a set of devices 120′ representing various users, each installed with a power management software application, allowing to share power management experiences with members of a social network community. Sharing power management experiences may include ranking power management services in various public areas, recommending power related accessories or various business locations, inviting friends to meet sharing coupons at such locations and the like.

It is noted that a wireless power transfer outlet 112 may be configured to initiate communication with the server application layer 130′, transmitting specific business data at time intervals via a channel (not shown), in a push mode. Additionally or alternatively, the system may be configured to support pull mode, or a combination thereof, where the initiation of a communication request may be performed by the server application layer 130′, thus the communication channel may be operable to support dual mode communication.

It is further noted that the raw data output from the lowest nodes (the wireless power receiver and the wireless power transmitter components) may be used as the input data to the whole integrated data gathering system, and may further undergo some formatting to answer possible requirements.

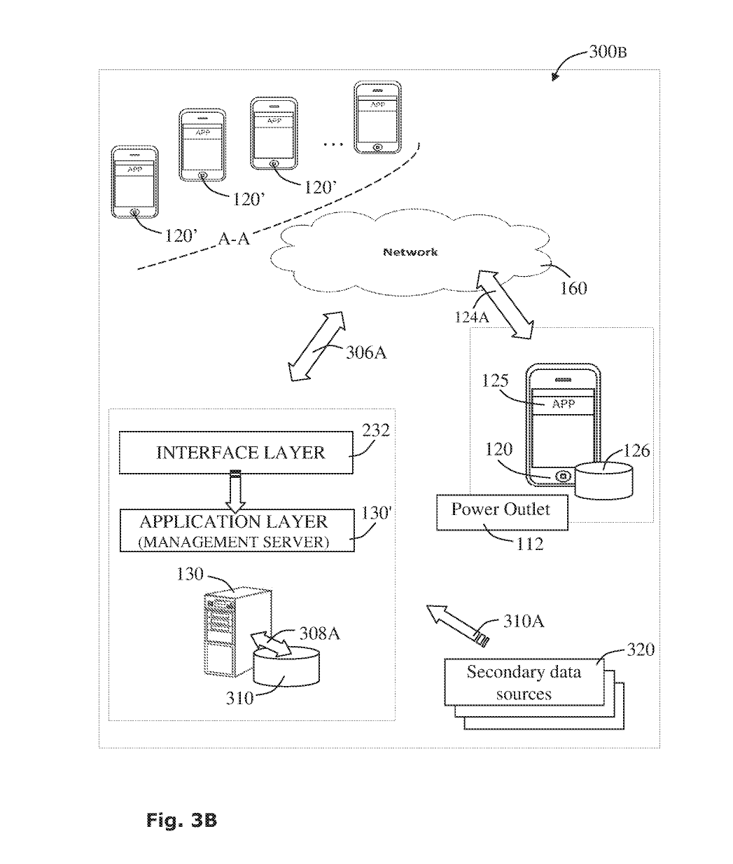

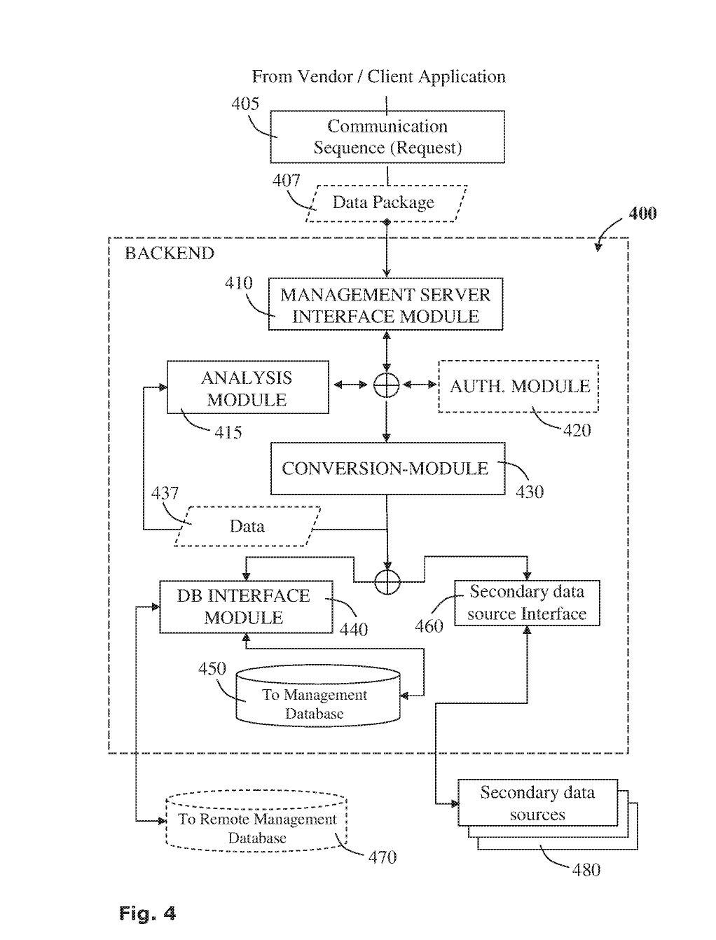

Reference is now made to the flowchart of FIG. 4 representing selected actions of a possible method 400 for backend processing of a communication request of business data gathering in a distributed system of wireless power transfer. The method 400 illustrates backend functionality of answering various communication requests such as storing, updating, retrieving data, authorization of request when necessary and the like, required to provide business data gathering using the system.

The method 400 includes a management server backend receiving a communication request 405 comprising a raw communication transmission framework, optionally containing a data package 407 with power transfer related information, for storing or updating the management database. The management server interface module 410 analyzing the received communication 405 and further, where appropriate forwarding the request to the authentication module 420 for performing authentication; to the conversion for extracting the data 437 from the data package 407, if exist; to the analysis module 415 for performing the required function, and further communicating with the database management 450 via the DB interface module 440. Additionally or alternatively, accessing proprietarily secondary data sources 480 using the related secondary data source interface 460.

It is noted that accessing secondary data sources may be required, if additional data is needed to complete producing a requested report with, for example, specific business information from additional sources such as governmental sources, commercial knowledgebase and the like.

It is further noted that the database management may be part of the management server backend, as shown (database management 450) or installed on a separate machine (database management 470).

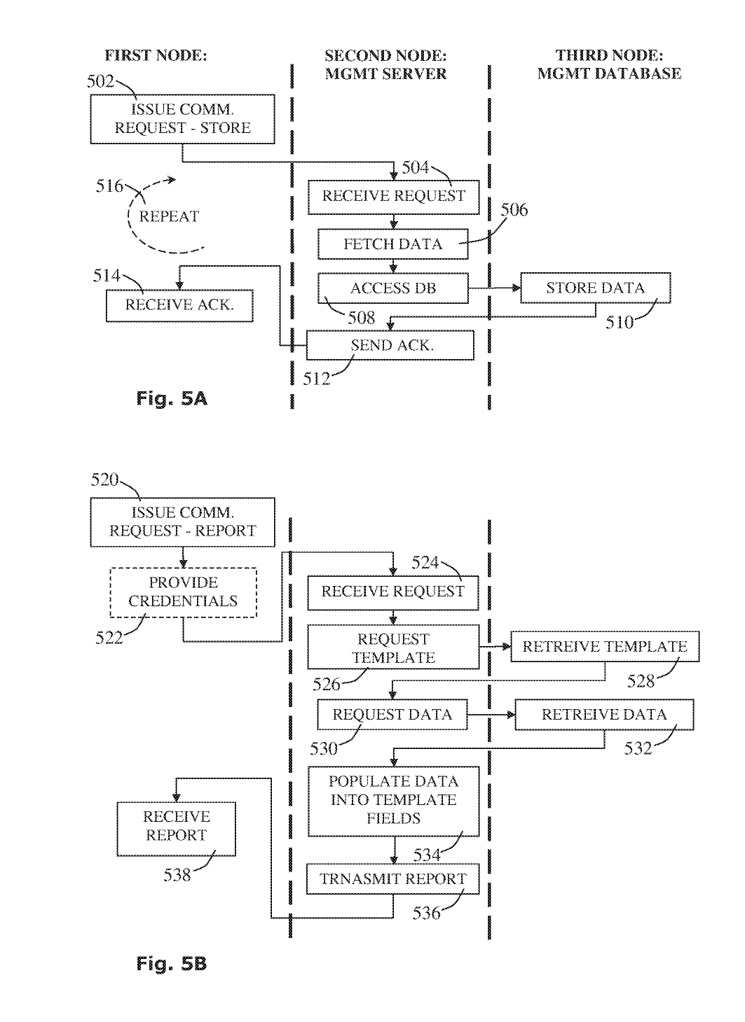

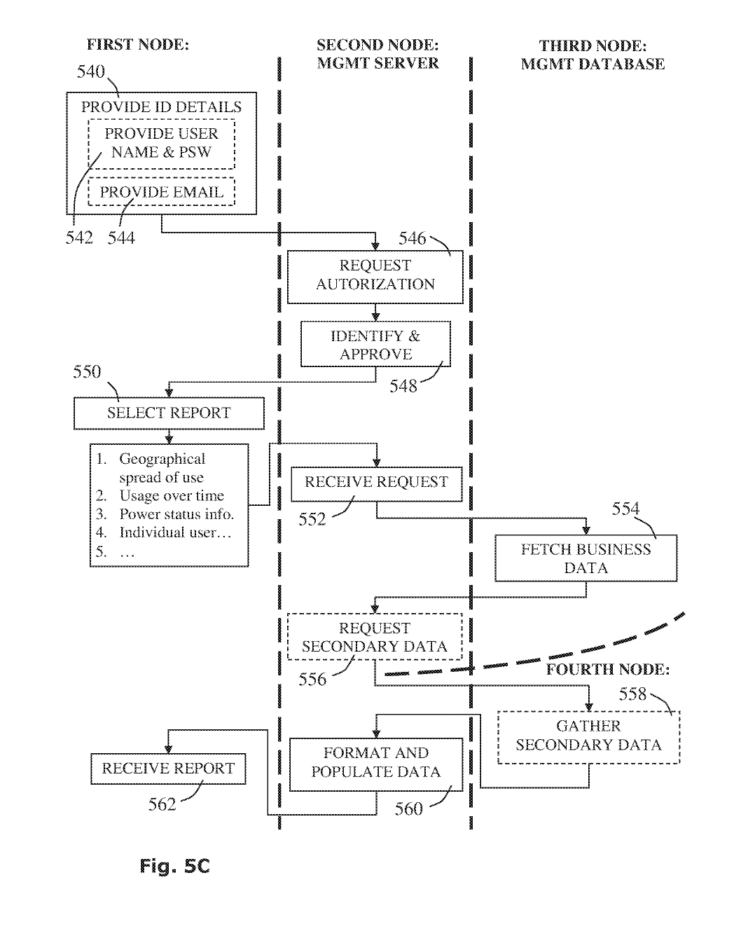

Reference is now made to the flowchart of FIGS. 5A-C representing selected actions illustrating possible methods for answering various communication requests in a multi-node client server system configuration related to data gathering from at least one wireless power transfer component in a networked environment, such as storing gathered data, retrieving data, various report creation and the like.

The method of FIG. 5A illustrates a possible communication request for storing data gathered into the database tier, FIG. 5B illustrates another possible communication request for generating a dynamic report based on a report template and FIG. 5C illustrates still another possible communication request for generating a static report selected from an existing set of possible reports such as service usage report, power status information report, geographical spread of use reports and the like.

Referring to the method of FIG. 5A, the method includes the wireless power transfer component, as the first node, initiating a data storage communication request 502 comprising a data package which further comprises data for storing, the management server as the second node, receiving the storage communication request 504 and extracting the data from the data package 506 and accessing the database 508, using the database interface to enable storing the data 510 into the management database, as the third node, and further acknowledging the successful operation of the storing request by submitting the notification to the management server 512 which is being forwarded accordingly 514 to the requesting agent.

It is noted that the communication request may further include a header with the necessary communication definitions according to the technology used.

It is further noted the whole process of storing data may be repeated 516, for each new store communicating request reaching the management server, from any of the wireless power transfer components.

Referring to the method of FIG. 5B, the method includes the terminal dashboard, as the first node, initiating a report generation communication request 520 to create a dynamic report. Optionally, the terminal dashboard initiating an authentication process, requesting the user to provide user credentials 522 (further detailed in FIG. 5C); the management server as the second node, receiving the report generation communication request 524; accordingly the management server application layer requesting the desired report template from the template repository 526; the database node, as the third node retrieving the requested report template 528; where appropriate, the management server application requesting the associated data 530 for generating the requested report; and the management database retrieving requested data 532; allowing the management server to populate the retrieved data into the template fields 534; management server application layer, transmitting the report 536 and optionally, the terminal dashboard receiving the report, possibly for further display or another sequential operation.

Referring to the method of FIG. 5C, the method includes the terminal dashboard, as the first node, initiating a communication request for static report generation 540. Optionally, the terminal dashboard is initiating an authentication process, requesting the user to provide user credentials—user name and password 542 and optionally providing email address; the second node, the management server application layer receiving the request authorization 546; performing a process of identifying the user by submitted credentials, and approving the request 548, if credentials are valid; user, selecting a possible report 550 from a set of options, such as geographical spread of use, usage over time in a specific location, power status information of a user, individual user power transfer history and the like; The application layer of the management server, receiving the request 552; retrieving the applicable business data 554 from the management database, and optionally, requesting secondary data 556, if applicable of the desired report. Then, gathering the secondary data (business web sites, business/academic/governmental knowledgebase(s) 558; application layer of management server, formatting the retrieved data and populating into report fields 560 and receiving the generated report by the terminal dashboard 562, possibly for further display or another sequential operation.

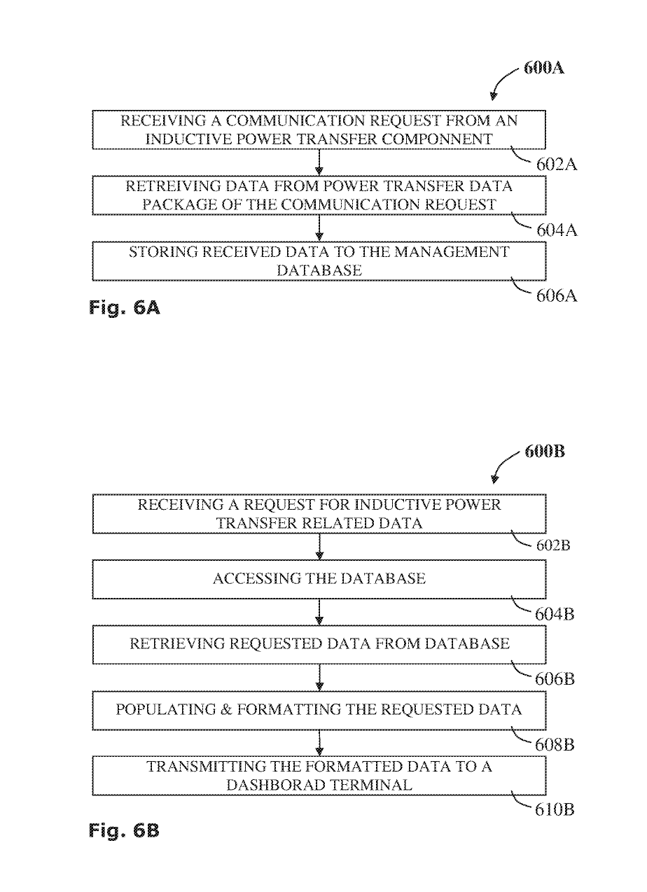

Reference is now made to the flowchart of FIG. 6A representing selected actions illustrating a possible method 600A to store power transfer related data into a database, operable on the application layer, of the management server. The method 600A includes the management server receiving a communication request from a wireless power transfer component 602A, wherein the communication request includes a power transfer data package detailing the context of information submitted for storing, by the wireless power transfer component. The application layer of the management server is retrieving the data itself from the received power transfer data package 604A and storing the received data to the database 606A.

Reference is now made to the flowchart of FIG. 6B representing selected actions illustrating a possible method 600B to retrieve power transfer related data stored in the database, operable on the application layer of the management server. The method 600B includes the management server receiving a communication request for wireless power transfer related data 602B; accessing the database 604B, providing credentials if requested by the management server application layer; retrieving the requested data from the database 606B, and further formatting and populating the data 608B; and transmitting the formatted data to the requesting dashboard terminal 610B.

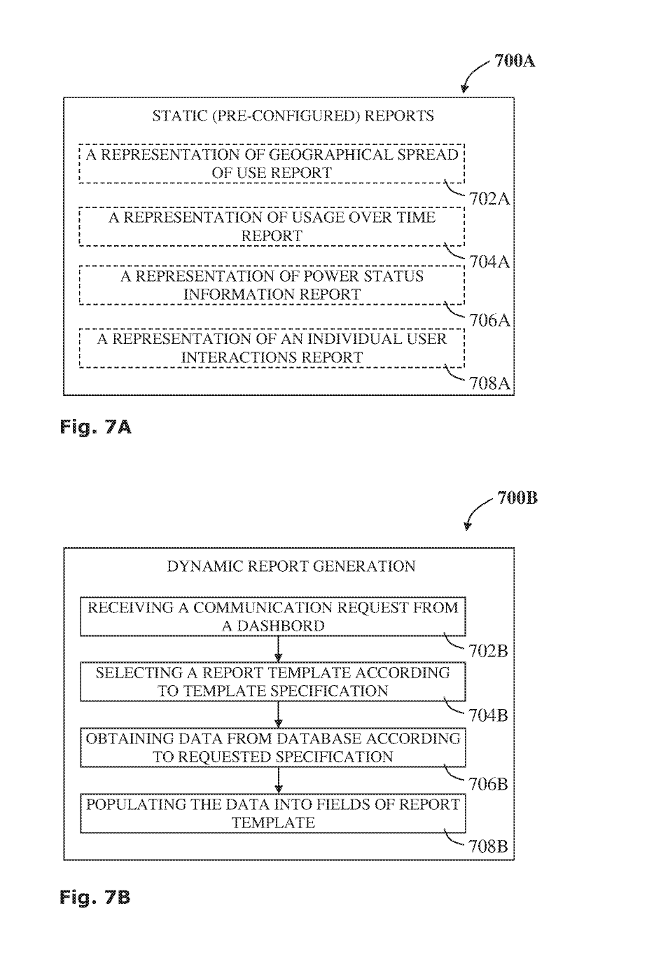

Reference is now made to the block diagram of FIG. 7A representing one possible set 700A of static, pre-configured reports, operable to be retrieved via the application layer of the management server from the database. The set 700A includes optionally, a representation of geographical spread of use report 702A; optionally, a representation of usage over time report 704A; optionally, a representation of power status information report 706A; and optionally, a representation of individual user interactions report over time report.

Reference is now made to the flowchart of FIG. 7B representing selected actions illustrating a possible method 700B to generate a dynamic report of power transfer related data, operable on the application layer of the management server. The method 700B includes the management server receiving a communication request from a dashboard 702B; selecting a report template according to template specification 704B; obtaining data from the database according to template specification and communication request 706B; and populating the received data into the applicable fields of the template 708B.

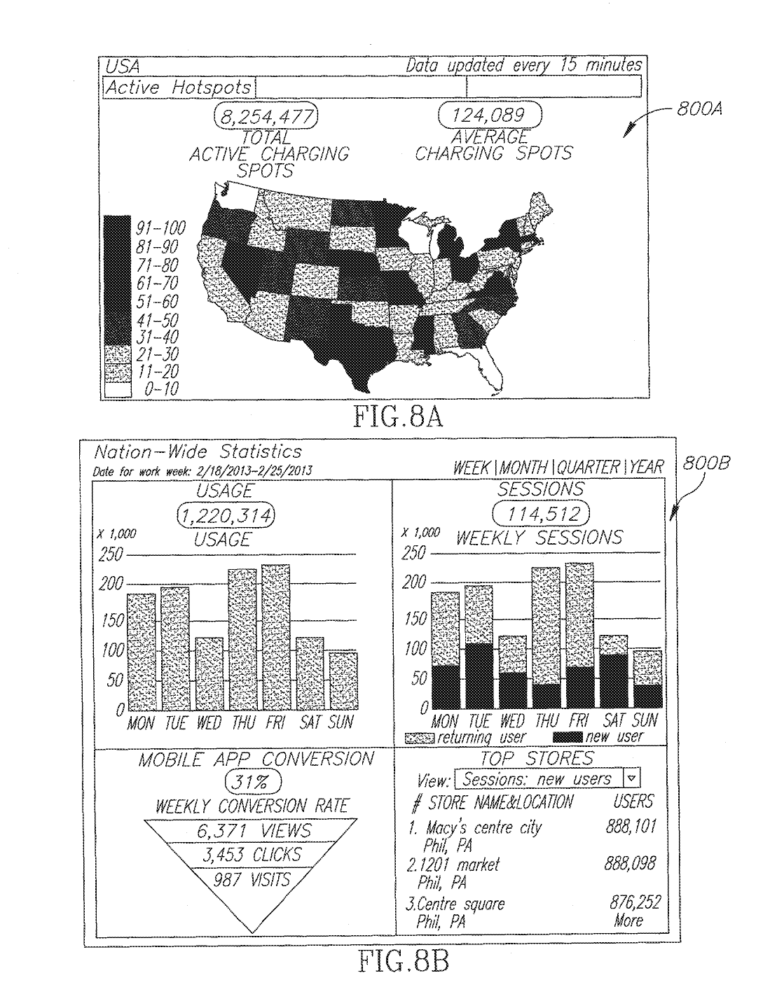

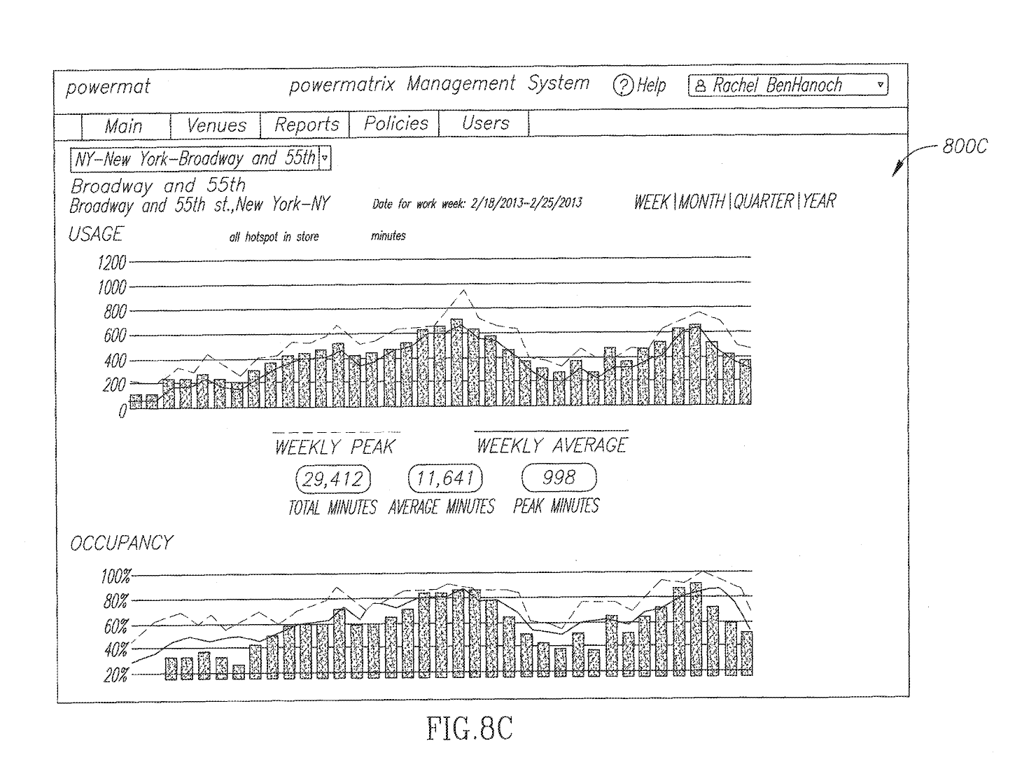

Reference is now made to the FIGS. 8A-C showing exemplary embodiments of representations of various type of possible reports.

FIG. 8A showing an exemplary embodiment of one possible representation of a geographical spread of use report 800A of active hotspots (active inductive power outlet units), operable to be retrieved or generated via the application layer of the management server from the database.

FIG. 8B showing another exemplary embodiment of one possible representation of a service usage over time combined with active sessions, to produce one possible sample nationwide statistics report 800B, operable to be retrieved or generated via the application layer of the management server from the database.

FIG. 8C showing an exemplary embodiment of one possible representation of a service usage over time report in a specific location report 800C, operable to be retrieved or generated via the application layer of the management server from the database.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

### Management and User Identification

It is noted that data gathering of a wireless power transfer system deployment, distributed in various geographical locations may provide additional revenue channels to a business using advanced data analysis methods applicable to the gathered data, and may offer direct and indirect incentives to business and individual users related by adding to future purchase of goods, maintenance, deployment changes to answer demand and the like, by providing a data analysis layer of usage reports, statistics and trends, for example.

In order to enable this type of model, a simple and convenient method may be required for associating a user with a specific electrical mobile device and to a specific wireless power outlet (wired or wireless), based upon identification data, and possibly synchronized by a close handshake communication of the devices.

The current disclosure relates to a system for enabling this task to be accomplished automatically and with no user intervention. The system may utilize preexisting transmitters that may be common amongst many mobile electrical devices with additional software management applications to them. Such an implementation may allow for the mass deployment of the system with little or no additional cost or inconvenience to the user.

It is particularly noted that although described primarily in relation to inductive power chargers, the current disclosure may apply to any power providing schemes and are not limited to say wired or wireless charging schemes.

Optionally, the customer configuration management portal may use various screens to allow various functional manageability, such as: Wireless power outlet management, Venues management, Users' management, Policy management, Reports, Auditing for configuring and managing systems' events, Security management and the like.

Optionally, Wireless power outlet management may allow summary view of live status, and detailed view of a specific store to allow managing the store's hotspots and gateways.

Optionally, the Users' management may allow the new customer's administrator to create or delete a store, assign or de-assign a store to a customer administrator (a system administrator functionality), assign or reassign stores to an operator, install a store (with gateways and hot spots), perform uninstall operations of various components, enable or disable users of a customer, issue reports for all the venues and the like.

Optionally, the Reports may allow the following: display graphical representation and textual output files of a single device, a single store or multiple stores; each report may be adjusted to visualize data for a defined week/month/quarter within the last twelve months; the graphical reports may be viewed, printed, or saved to a file in a graphical format, or saved to file in a data format used to generate the report. As appropriate, the generated reports may provide usage per store of the total power transfer time in minutes, say, for a defined period, where store may be identified by a store ID; charging hotspot utilization for a 24 hour cycle, say, providing the average daily time, in minutes say, per a hotspot per a store; usage per date and trend, providing total power transfer time, in minutes say, per date for all stores, with a linear trend line and possibly, define weekdays and/or weekends in the display; sessions, providing distribution of lengths of sessions and average session length; charging per time of day providing total charging minutes for all stores per hour of day for the defined period; repeat usage, providing rate of returning users and number of repeat visits for power transfer; and device type providing distribution per type of device.

Optionally, auditing may allow the following: create log data for every important event in the system, including: installation or removal of a gateway, installation or removal of a hotspot, rejecting a hotspot as a not “legitimate” hot spot (not in production database), definition or cancelation of a user, customer or store, creation of SN generator file and others.

Optionally, Policy management may allow the following: creating basic policy for power transfer per each day of the week, weekend specific power transfer policy, time slot resolution per a hotspot (or all hotspot in a store) such as a hotspot is active between 8 am-1 pm and 4 pm-7 pm, for example. Further, a policy may be executed at once on all hotspots per store, such as disabling all hotspots or enabling all. Optionally, when a hotspot is configured as ‘not available’ per policy, its status may be indicated a LED color, red say, for ‘unavailable’.

It is noted that hotspots availability may be greater than the advertised time.

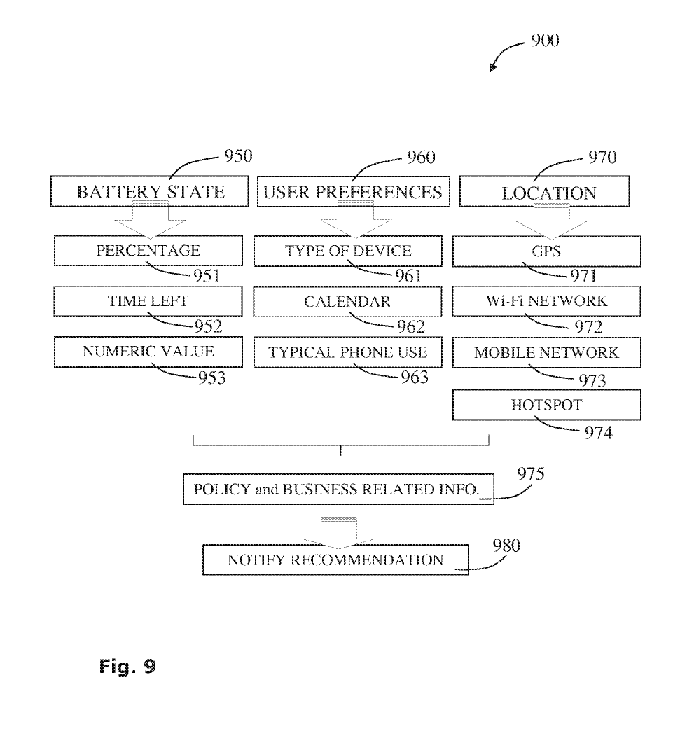

Reference is now made to the block diagram of FIG. 9 representing possible procedure 900 for providing the end user with a complete analysis set of results and recommendations, when a low power level event is triggered. The possible procedure 900 may include battery state 950 data, user preferences 960 data and location 970 information combined with policy and business related information 975 to trigger an analysis considering the three data sets to provide a set of options, selectable by the end user.

The battery state 950 data, indicating the battery current power level, may be indicated by a percentage value 951 or a time left indication 952. Optionally, the battery power level may refer to a numeric value indicating full capacity, and accordingly lower level may have relative numeric values.

It is noted that the state of low battery may take a default value, or may allow different user configured setting.

The user preferences 960 data, are reflections of interactions between the user and the mobile device that may analyze and studied to gather user preferences, learning what the user likes the most, and to use this information to personalize the presentation of results and recommendations. The user preferences 960 data, may include type of device 961, calendar entries to account for possible activities, typical phone used 963 based on user interactions like watching video content or movies, preferred web sites, communication in the social space, favorable software application usage and the like.

The location 970 data, indicates the current user location to allow appropriate offerings to the user. The location 970 data may be obtained via mobile device embedded GPS system 971. Optionally, current location may be configured via the communication network in practice—Wi-Fi network 972 or the cellular network 973. Additionally, if the electrical device is associated with a specific wireless power outlet in some public space, than its location may be derived from the wireless power outlet device.

In particular, it is noted that the power management software running on the device may receive the TxID and/or the location of the wireless power outlet (the hotspot). Information regarding the location of the Hotspot may be associated with the TxID. Such location information may be programmed into the Hotspot at, e.g., the time of installation, and may provide very accurate location information, which may be more accurate than what may be provided through other methods, such as GPS or antenna triangulation. Where the power management software is an application, the Hotspot may transmit information regarding itself (e.g., TxID, location, and the like) to the device, which then transfers the information to the application. The application may further identify the location using GPS, antenna triangulation, in-door positioning methods and the like.

It is further noted that policy and other business related matters and procedures 975, may be stored centrally in a server (130, FIG. 1A), may include power transfer policies of service supplier/provider, various policies/agreements/offerings of public area entities that may be relevant from end user perspective, and the like.

It is further noted that additional data may allow to reach better recommendation, by incorporating data from the social space like social ranking, social member in the vicinity and the like.

The outcome of the procedure may yield options enabling the user to get address and business hours, locate the public entity destination on a map, get driving directions, adjust search radius to reduce or expand number of possible options, filter by brand of the public entities, filter by ranking of social space members, number of Hotspot in a specific public entity, coupons and promotions, receiver accessories sales and the like.

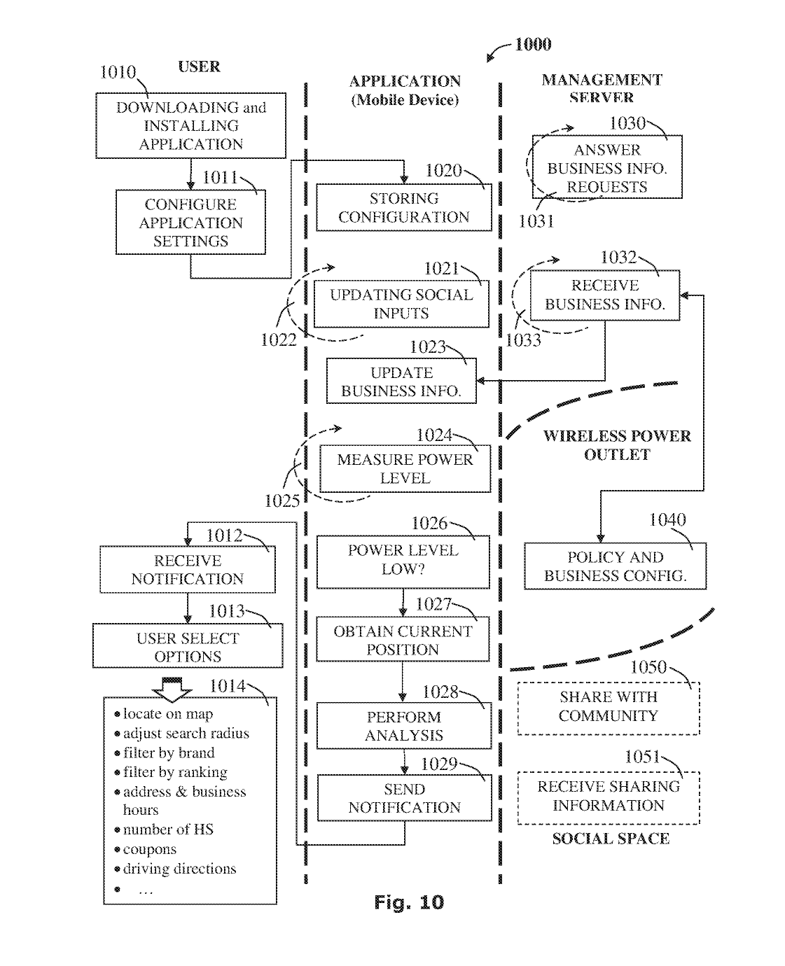

Reference is now made to the flowchart of FIG. 10 representing selected actions illustrating possible method 1000 for answering various communication requests in a multi-node client server system configuration related to a power management application, comprising at least one user running a power management application on an electrical mobile device, at least one management server configured for storing information related to wireless power network and various store facilities in different business aspects, providing wireless power transfer services with at least one wireless power outlet installed to provide such service.

Amongst others, such public settings may include restaurants, coffee shops, airport lounges, trains, buses, taxis, sports stadia, auditoria, theatres, cinemas or the like. Further, there is a need for such systems to enable tracking of individual mobile devices, in order to provide a platform for efficient powering services.

The method 1000 includes activities performed by a user, downloading power management software application for example from an online app store or accessing a web-based application, and further installed on his/her electric mobile device 1010; and optionally configuring the default values of the software application settings 1011, and upon a ‘save’ request, the new settings may be stored by the power management application, optionally in a local storage device 1020. The software application may run parallel processes such as updating social communications 1021 in a repeated manner 1022, arriving from members of the social community, sharing power transfer experiences with the community 1050, while receiving social communications from other members 1051.

Additionally or alternatively, the software application may further update business related information 1023 received from the node of the management server 1032, partially updated by the system administration of the distributed system or automatically updated by direct communication from various businesses 1033.

Optionally, the software installed on the wireless power outlet may communicate the setting configurations of the wireless power outlet itself, to the central management node 1040 and may further transmit additional communication information when an electric mobile device is being associated.

Where appropriate, the software application measures repeatedly 1025 the power level of the electrical device power storage unit (battery) 1024. The repeated manner or time interval of measuring may use default setting or the user configured setting. When the measurement indicates that the power level is lower than threshold value 1026, it may trigger obtain current position of the electric mobile device 1027 and perform analysis 1028 based upon current location, user preferences and current business policy.

It is noted that current position may be obtained via mobile device embedded GPS system or such like. Optionally, current location may be configured via the communication network in practice—Wi-Fi or the cellular network. Additionally, if the electrical device is associated with a specific wireless power outlet, than its position may be derived from the outlet device.

Accordingly, the analysis brings about a set of possible options, and submits a notification 1029 to the end user to select the desired option 1014.

Variously, the end user may be triggered to select an option from a group comprising location on a map, adjusting the search radius to increase/decrease possible options, filtering by brand, filtering by ranking as categorized by social network members, obtain address of the business and opening hours, number of wireless power outlet (hotspots) in a selected business, associated coupons of a selected business, driving or walking directions or a combination thereof.

It is noted that a user may further share his experience with his social spaces, such as recommending the place to other social members, ranking the wireless power transfer experience of a specific public business entity and the like.

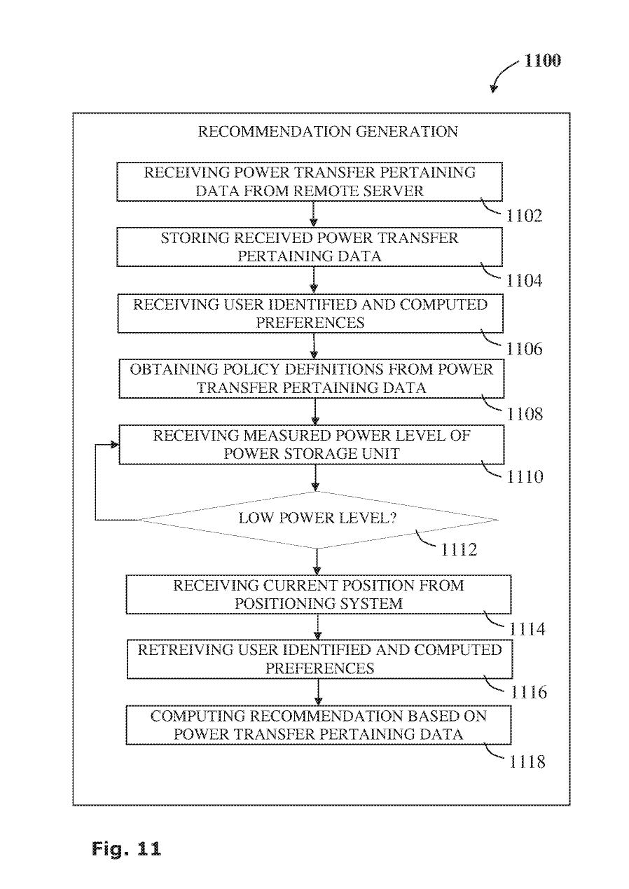

Reference is now made to the flowchart of FIG. 11 representing selected actions illustrating a possible method 1100 of generating power related recommendation based upon current user location, power level of the power storage unit of the electrical device, user preferences and power transfer policy data and other business related information and agreements, operable to be executed on an electric device. The method 1100 includes the electrical device receiving a communication message containing power transfer related or pertaining data 1102, such as policies and other business information; storing the received power transfer related or pertaining data 1104, providing data for further recommendation analysis, when required; receiving current state of user identified preferences, adjusted with computations 1106, and further obtaining policy definitions from the stored power transfer related or pertaining data 1108; and receiving measured power level of the power storage unit of electrical device 1110; If power level of power storage unit is above the lower limit of the default value 1112, step 1110 of measuring is repeated at a cycle, optionally preconfigured, otherwise a default testing value may be used.

It is noted that referencing policies and other business information, may refer, for example to charging policy of a store providing wireless power transfer services, allowing to compare between policies to provide a better recommendation to the end user. Optionally, a user may select to view the charging policy of a specific store.

It is further noted that, referencing policies and other business information, may refer, as another example to business agreement between the power transfer provider and the store enabling to display adverts associated with user preferences, offering beneficiary products or coupons to the end user.

If power level of power storage unit is below the lower limit of the default value 1112, then retrieving the current location to enable to compute a recommendation for the user as to the nearest power transfer location, based upon location, user preferences and associated business data.

It is noted that all default values, such as limits for minimum power level, repeat time and the like may be configurable by the user.

### Business Power Management—the Software Application

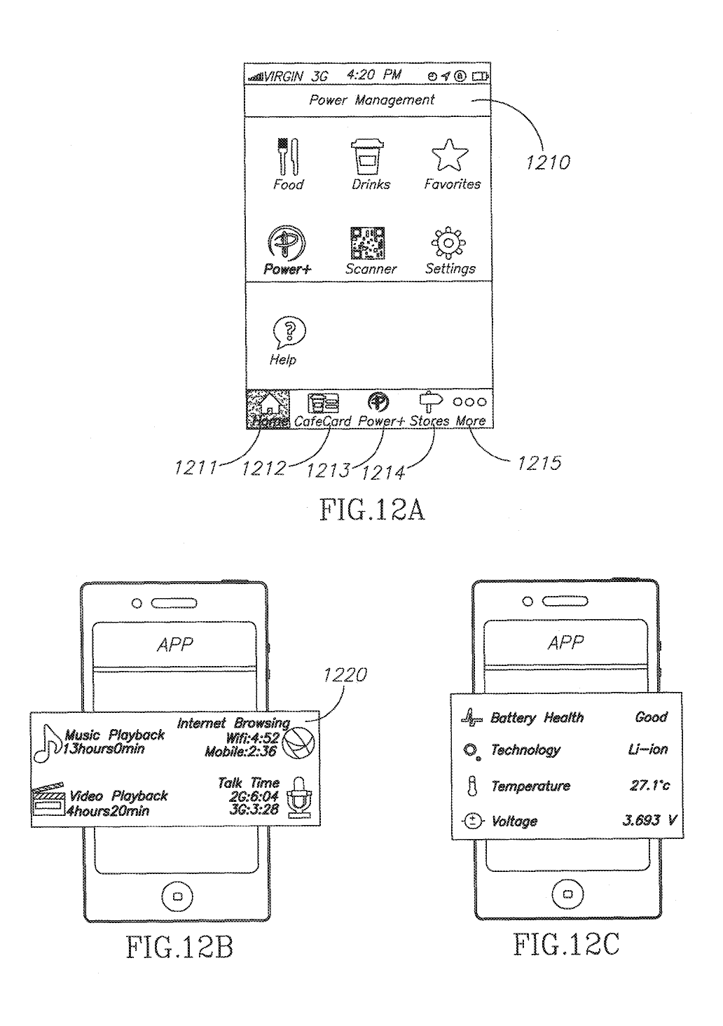

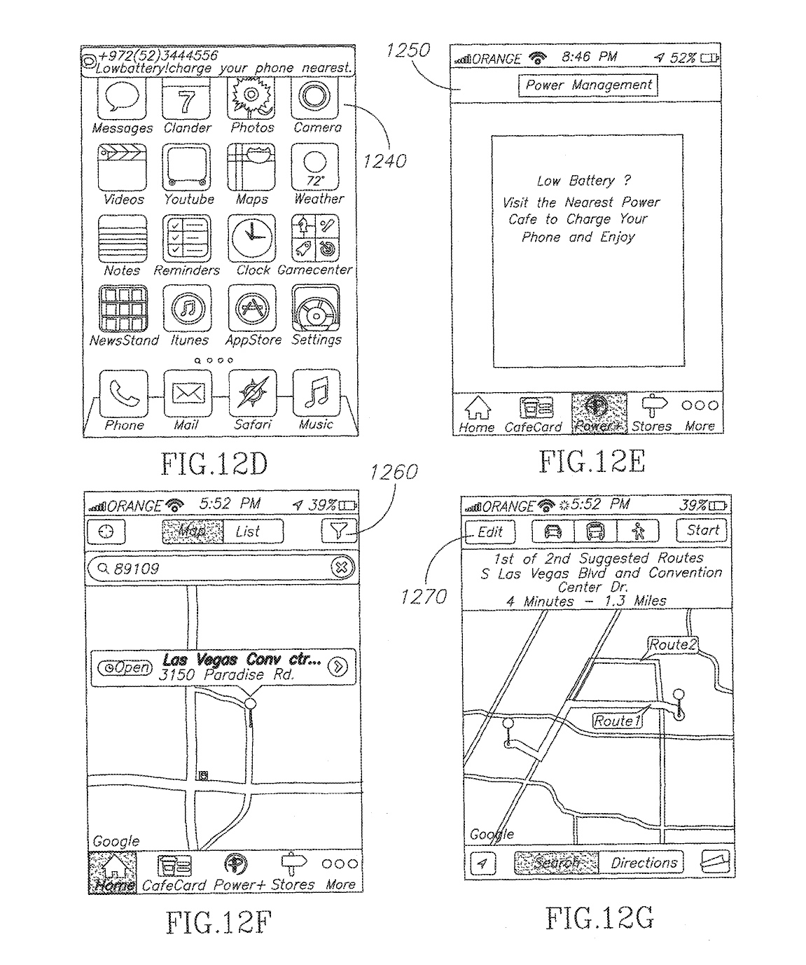

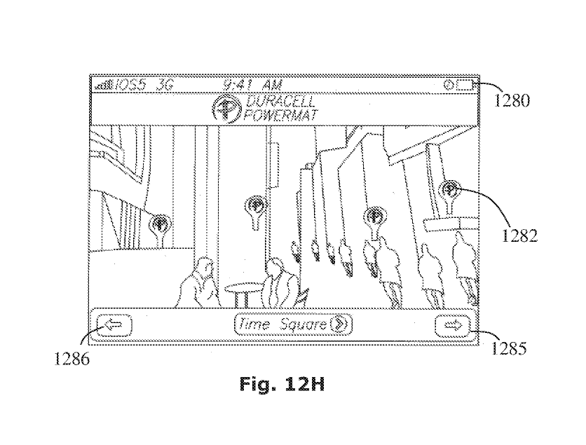

In order to better illustrate the possibilities of the power management software, FIGS. 12A-H show a selection of possible partial screen shots of a graphical user interface for a touch screen of a mobile device executing the power management software application, which may be in the form of a pre-installed or downloaded application or a part of the device OS. Referring particularly to FIG. 12A, a possible screenshot 1210 is represented of a home screen of a power management software which may be installed and accessed from a mobile communications device such as a computer, smart phone, a tablet computer, games console or the like.

The home screen icons may direct the user to other screens providing various functionality such as described herein. For example, a first icon may direct the user to a “operable remaining time” screen, such as shown in FIG. 12B, a second icon may direct to a “battery status screen” such as shown in FIG. 12C, a third icon may return a user to the home screen, a fourth icon may direct a user to a “Power transfer outlet locator screen” such as shown in view 1260 of FIG. 12F and more.

It is noted that the power management software application may integrate additional functions directly related to the process of wireless power transfer, billing and the like. Such related functionalities may refer to various indications such as ‘start of power transfer’, ‘remaining time’ indication for completion, ‘end of power transfer’, credit charging, buying credits, buying related accessories and the like.

FIG. 12F shows a possible screen shot of a “Power access point locator” screen of a power management software application. The “Power access point locator” screen may allow a user to locate a wireless power outlet (power access point, PAP) in the vicinity based upon location, battery power level, user preferences and pre-configured policy and other related business information. The screen may display a map indicating the location of the nearest power access points. Optionally, a user may select the arrow icon on the map popup to be redirected to a “get directions” screen such as shown in FIG. 12G.

FIG. 12B, screen shot 1220 shows a possible notification message overlaid upon a home screen of an electrical device, such as an iPhone or the like. Such notification may show time left for each type of activity possibly carried out on the device. The power management software may be configured to learning user's battery draining regularity, thus providing the ‘remaining battery time’ based on the user's real usage pattern, in a granularity of weekdays/weekends and time of day, such as time remaining for music playback, internet browsing either using Wi-Fi or mobile network, video playback using 2G or 3G and the like.

It is noted, that further battery health indications may be retrieved by using OS API calls, as shown in FIG. 12C, screen shot 1230 such as assessment of battery health, type of technology, temperature and existing current voltage.

FIG. 12D shows a possible notification message 1240 overlaid upon a home screen of a communications device, such as an iPhone or the like. Text may be displayed such as: “Low battery! Charge your phone in the nearest power access point.” Optionally the notification may include promotional material such as a message like “Low battery! Charge your phone in the nearest café and enjoy BUY 1 GET 1 promotion”. The notification area may remain until a user clicks on it then a message such as “Find nearest power transfer station screen” may be displayed. It is further noted that that such recommendations are analyzed constantly and are updated to reflect the current user location.

FIG. 12E shows a possible screen shot 1250 of a “Low Power” popup screen of a power management software. The popup screen, may further include an option to “find nearest charging station”, and may further direct to a “Store locator” screen, such as an augmented reality display of a camera view with icons denoting the location of stores having power transfer stations 1282, for example, as shown in screen shot 1280 of FIG. 12H. The popup notification may have a close icon, such as an X or a selection button, for closing the notification and redirect the user to home screen. Further, the screen may enable moving forward and backward with the arrow buttons 1285 and 1286, displaying additional views of the store locations or continuous video viewing of the location.

It is noted that, same functionality may be applicable to store or events recommendations in the vicinity of current location.

### Usage Scenarios

By way of example only, a number of usage scenarios of the power transfer system are described hereinafter:

According to a first usage scenario, the power management software may include a “Battery low scenario” which a user may be launched automatically when the value of battery power level is below a pre-configured threshold or, may be accessed, for example, by selecting a “low battery” option on a bottom bar of the software application screen.

Accordingly, a low battery push notification may be displayed, when the event takes place.

Optionally, the user may select a feature to find a wireless power transfer station. For example, the user may be presented with a map indicating the locations of nearby power transfer outlets or charging stations, perhaps using a global positioning system (GPS) to provide current location. The user may further select a particular wireless power transfer outlet on the map and be presented with directions as well as other details, such as associated special offers and the like, as required.

Additionally, in other options, a power management software application may provide a locator feature using augmented reality to indicate the locations of nearby wireless power transfer outlets upon an overlay superimposed upon an image captured from the devices camera. An example of such a display is shown in FIG. 12H.

Optionally, links may be provided to social media allowing a user to communicate with or access feedback from other users of various wireless power transfer outlet locations and their environments.

Having identified a wireless power transfer outlet location, the user may return to the home screen, perhaps by tapping anywhere on the current screen. The Power management software may be initiated by selecting an initiation button such as a “Touch to charge” button or the like. A communication device such a mobile telephone, smart phone, PDA or the like may be connected to the wireless power transfer outlet. For example a device having an associated wireless power receiver may be placed on a wireless power outlet and power transfer, for example charging of the device, may begin.

While power is transferred, or the device is charged a countdown popup may be displayed optionally along with dynamic promotions, optionally based on current location, time required to complete power transfer and user personal preferences

Optionally, where applicable, the power management application may further display the remaining time until a device will be charged.

Optionally, promotion popup may be displayed during or after the power transfer is completed.

According to another usage scenario a web application may be set to a default time limit of 1 minute, or so, of time based credit with no free or blocked periods defined. A user may launch a power management software and accesses the power management screen. A code may be entered into the power management screen and the charging credit may be updated to the default value of say 1 minute.

The user may enter the power management software screen and tap on an initiation button such as a “touch to charge” button or the like.

A communication device such as a mobile telephone, smart phone, PDA or the like may be connected to the wireless power transfer point. For example a device having an associated wireless power receiver may be placed on a wireless power outlet and power transfer, for example charging of the device, may begin.

While power is transferred, or the device is charged a countdown popup may be displayed optionally along with dynamic promotions.

The web application may be operable to indicate that the wireless power transfer outlet is busy. Optionally, where applicable, the power management application may further display the remaining time until a device will be charged and this may be synchronized with the counter of the power management software on the device.

Optionally, again, promotion popup may be displayed during or after the power transfer is completed. As appropriate, similar promotion pop up indication may be display while in public space, and battery status indicates a need for charging, if battery power level is beyond a preconfigured threshold.

Technical and scientific terms used herein should have the same meaning as commonly understood by one of ordinary skill in the art to which the disclosure pertains. Nevertheless, it is expected that during the life of a patent maturing from this application many relevant systems and methods will be developed. Accordingly, the scope of the terms such as computing unit, network, display, memory, server and the like are intended to include all such new technologies a priori.

As used herein the term “about” refers to at least ±10%.

The terms “comprises”, “comprising”, “includes”, “including”, “having” and their conjugates mean “including but not limited to” and indicate that the components listed are included, but not generally to the exclusion of other components. Such terms encompass the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” may include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments or to exclude the incorporation of features from other embodiments.

The word “optionally” is used herein to mean “is provided in some embodiments and not provided in other embodiments”. Any particular embodiment of the disclosure may include a plurality of “optional” features unless such features conflict.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. It should be understood, therefore, that the description in range format is merely for convenience and brevity and should not be construed as an inflexible limitation on the scope of the disclosure. Accordingly, the description of a range should be considered to have specifically disclosed all the possible sub-ranges as well as individual numerical values within that range. For example, description of a range such as from 1 to 6 should be considered to have specifically disclosed sub-ranges such as from 1 to 3, from 1 to 4, from 1 to 5, from 2 to 4, from 2 to 6, from 3 to 6 etc., as well as individual numbers within that range, for example, 1, 2, 3, 4, 5, and 6 as well as non-integral intermediate values. This applies regardless of the breadth of the range.

It is appreciated that certain features of the invention, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the invention has been described in conjunction with specific embodiments thereof, it is evident that other alternatives, modifications, variations and equivalents will be apparent to those skilled in the art. Accordingly, it is intended to embrace all such alternatives, modifications, variations and equivalents that fall within the spirit of the invention and the broad scope of the appended claims.

Additionally, the various embodiments set forth hereinabove are described in terms of exemplary block diagrams, flow charts and other illustrations. As will be apparent to those of ordinary skill in the art, the illustrated embodiments and their various alternatives may be implemented without confinement to the illustrated examples. For example, a block diagram and the accompanying description should not be construed as mandating a particular architecture, layout or configuration.

The presence of broadening words and phrases such as “one or more,” “at least,” “but not limited to” or other like phrases in some instances shall not be read to mean that the narrower case is intended or required in instances where such broadening phrases may be absent. The use of the term “module” does not imply that the components or functionality described or claimed as part of the module are all configured in a common package. Indeed, any or all of the various components of a module, whether control logic or other components, can be combined in a single package or separately maintained and can further be distributed in multiple groupings or packages or across multiple locations.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a computer-readable medium such as a storage medium. Processors may perform the necessary tasks.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present disclosure. To the extent that section headings are used, they should not be construed as necessarily limiting.

The scope of the disclosed subject matter is defined by the appended claims and includes both combinations and sub combinations of the various features described hereinabove as well as variations and modifications thereof, which would occur to persons skilled in the art upon reading the foregoing description.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

1-11. (canceled)

12. A computer implemented method for use in a system for gathering data pertaining to an inductive power transfer network in an improved manner, said network comprising:
at least one inductive power transfer component operable to manage power transfer between an inductive power outlet and an inductive power receiver;
at least one management server in communication with said at least one inductive power transfer component; and
a database in communication with said management server and operable to store data received by said management server from said at least one inductive power transfer component, the method comprising the steps of:
said management server receiving a communication request from said at least one inductive power transfer component, wherein said communication request comprises at least one power transfer data package;
said management server obtaining data received from said at least one power transfer data package;
said management server storing said data received into said database; and
said management server generating a report, said report comprising at least one of:
a report of geographical spread of use of said at least one inductive power transfer component;
a report of usage over time of said at least one inductive power transfer component;
a report of power status information of a mobile device; and
a report of an individual user interactions to identify repeating users pattern.

13. The method of claim 12, wherein said at least one power transfer data package comprises data pertaining to at least one of a group consisting of:
location of said at least one inductive power transfer component, characteristics of said inductive power receiver, characteristics of said inductive power outlet, power status data, at least one recordation timestamp, power transfer duration, user specific identification, business of said location, and combinations thereof.

14. The method of claim 13, wherein said management server is further connectable to a dashboard terminal, said method further comprising the steps of:
said management server accessing said database;
said management server obtaining a data set from said database; and
said management server presenting said data set onto said dashboard terminal

15. The method of claim 14, further comprising:
said management server formatting said data set into a formatted data set; and
said management server transmitting said formatted data set to said dashboard terminal.

16-17. (canceled)

18. The method of claim 12, wherein said step of generating a report comprises the steps of:
said management server, receiving a request for a report associated with a template specification;
said management server selecting a report template according to said template specification from a template repository;
said management server obtaining data for said report according to said report template; and
said management server populating said data into fields of said report template.

19. The method of claim 18, wherein said template specification is characterized by at least one of the following:
location of said inductive power outlet,
characteristics of said inductive power receiver,
characteristics of said inductive power outlet,
characteristics of power status data,
at least one recordation timestamp,
characteristics of power transfer duration,
characteristics of user specific identification,
characteristics of business at said location, and
combinations thereof.

20. The method of claim 13, further comprising at least one step of:
said management server monitoring said at least one inductive power transfer component, such that said management server receives multiple periodic data packages at intervals, from said at least one inductive power transfer component being monitored or
said management server controlling said at least one inductive power transfer component.

21. (canceled)

22. The method of claim 13 further comprising the step of said management server providing service for battery optimization for said at least one inductive power transfer component;
said management server, receiving registration request, and said management server, updating a registration list stored in said database; or
said management server, receiving a communication request, said management server, performing verification against an authorization list stored in said database, and said management server, authorizing said communication request, if said verification is successful.

23. The method of claim 15, wherein said dashboard terminal is selected from a group consisting of a workstation, a laptop, a tablet, a smartphone, a screen display, a mobile data terminal, a panel display, a handheld device, a PDA, and combinations thereof.

24-35. (canceled)

36. A computer implemented method for use on an electrical device operable by a user and configured to receive data pertaining to a wireless power transfer network in an improved manner, said electrical device comprising:
a power storage unit operable for receiving wireless power transfer;
a wireless power receiver operable to connect to a wireless power outlet;
a data storage component operable to store data pertaining to power transfer pertained data; and
a processor,
the method comprising the steps of:
said processor receiving data pertaining to wireless power transfer;
said processor storing said data in said data storage unit;
said processor receiving a current position of said electrical device;
said processor receiving a measurement of a current power level of said power storage unit from said wireless power receiver; and
said processor, generating an alert according to said current position, said current power level and said data pertaining to wireless power transfer.

37. (canceled)

38. The method of claim 36, wherein said power storage unit is selected from a group consisting of a rechargeable battery, an electrochemical cell, and combinations thereof.

39. The method of claim 36, further comprising the steps of:
said processor, determining user preferences associated with said user; and
said processor, storing said user preferences in said data storage component.

40. The method of claim 36, wherein said step of receiving data pertaining to wireless power transfer, said electrical device is further operable to communicate with a remote server, said method further comprises the step of:
said processor, receiving at least one communication message from said remote server, said at least one communication message comprising said data pertaining to wireless power transfer.

41. (canceled)

42. The method of claim 36, wherein said step of receiving current position further comprises the steps of:
said processor, communicating with a positioning system; and
said processor, receiving said current position from said positioning system,
wherein said positioning system is selected from a group consisting of a satellite positioning system, a radio signal positioning system, and a cellular network, and combinations thereof.

43. The method of claim 36, wherein said step of receiving current position comprises:
said processor, receiving said current position from said wireless power outlet.

44. The method of claim 36, wherein said data pertaining to wireless power transfer is selected from a group consisting of user specific identification data, user specific contract data, power transfer business policy, characteristics of at least one business around said current location, set of adverts associated with said at least one business, recordation timestamps, and combinations thereof.

45. The method of claim 36, further comprising the steps of:
said processor, receiving a selection of a social network from said user;
said processor, receiving a selection of at least one member of said social network from said user and an associated communication message; and
said processor, transmitting said associated communication message to said at least one member.

46. The method of claim 36, wherein said electrical device is further operable to communicate with at least one secondary source via a management server, said method further comprising the steps of:
said processor accessing said at least one secondary source; and
said processor obtaining data pertaining to said business.

47. The method of claim 46, wherein said at least one secondary data source comprises at least one of a group consisting of a social network, a public record, a government record, a legal record, a company website, and combinations thereof.
